(19) United States
(12) Patent Application Publication
(10) Pub. No.: US 2014/0006806 A1
(43) Pub. Date: Jan. 2, 2014

(54) EFFECTIVE DATA PROTECTION FOR MOBILE DEVICES

(71) Applicants: Francisco Corella, San Jose, CA (US); Karen Pomian Lewison, San Jose, CA (US)

(72) Inventors: Francisco Corella, San Jose, CA (US); Karen Pomian Lewison, San Jose, CA (US)

(73) Assignee: POMIAN & CORELLA, LLC, San Jose, CA (US)

(21) Appl. No.: 14/016,022

(22) Filed: Aug. 30, 2013

Related U.S. Application Data
(63) Continuation-in-part of application No. 13/954,973, filed on Jul. 30, 2013.
Application No. 13/954,973 is a continuation-in-part of application No. 13/925,824, filed on Jun. 24, 2013.
(60) Provisional application No. 61/695,293, filed on Aug. 30, 2012.
(60) Provisional application No. 61/663,569, filed on Jun. 23, 2012.
(60) Provisional application No. 61/677,011, filed on Jul. 30, 2012.
(60) Provisional application No. 61/804,638, filed on Mar. 23, 2013.
(60) Provisional application No. 61/809,790, filed on Apr. 8, 2013.

(51) Int. Cl. G06F 21/62

(52) U.S. Cl. CPC G06F 21/62
USPC 713/193

(57) ABSTRACT

A method of protecting confidential data stored in a computing device. In one embodiment, data items are encrypted using content-encryption keys that are not present in the device while the device is locked. When a user unlocks the device, the content- encryption keys are computed using at least one externally stored key that is retrieved from a key storage service using a credential regenerated from a protocredential stored in the device and one or more secrets supplied by a user.

### CROSS-REFERENCE TO RELATED APPLICATIONS

This application claims priority to U.S. Provisional Application Ser. No. 61/695,293, filed on Aug. 30, 2012, and is a continuation in part of U.S. Non-Provisional Patent Application Ser. No. 13/954,973, filed on Jul. 30, 2013, which is a continuation-in-part of U.S. application Ser. No. 13/925,824, filed Jun. 24, 2013, which claims priority to U.S. Provisional Application Ser. No. 61/663,569, filed on Jun. 23, 2012, U.S. Provisional Application Ser. No. 61/677,011, filed on Jul. 30, 2012, U.S. Provisional Application Ser. No. 61/804,638, filed on Mar. 23, 2013, and U.S. Provisional Application Ser. No. 61/809,790, filed on Apr. 8, 2013, all of which applications are incorporated herein by reference.

### BACKGROUND

Mobile devices such as smart phones and tables are easily lost or stolen. Data stored in a mobile device should therefore be protected against an adversary who captures the device.

A traditional method of protecting data stored in a user-controlled device is to encrypt the data using a symmetric data encryption key derived from a passcode. The key is discarded when the user locks the device. The passcode is supplied by the user when the user unlocks the device. The key is then derived from the passcode and used to decrypt the data. However this method is only effective if the passcode has high entropy, which requires the passcode to be long and contain letters, digits and other characters.

Since it is cumbersome to enter a mixed character string on a touch screen keyboard, the passcode is typically entered on a numeric keypad; and since device unlocking is an operation that must be performed frequently, the passcode is typically only four digits long, i.e. it is a four-digit personal identification number (PIN). A four-digit PIN having very low entropy, data protection based on encryption by a key derived from a four-digit PIN is easily defeated.

A prior art improvement on the traditional method of encrypting the data using a data encryption key derived from a passcode is to derive the data encryption key from both a passcode and a protected key kept stored in a cryptographic module, which cannot be extracted from the module. An adversary who captures the device and is able to jailbreak the device may use custom code to instruct the cryptographic module to derive guesses of the data encryption key from guesses of the passcode. The module uses a purposefully slow key derivation algorithm to reduce the rate of guessing, But the algorithm cannot be too slow without making the device unlocking operation impractical for the legitimate user. A patient adversary is therefore able to guess a low entropy passcode. For example, at the rate of one guess per tenth of a second, the adversary can try all possible 4-digit PINs in 16 minutes 40 seconds, and at the rate of one guess per second, in 2 hours 46 minutes and 40 seconds.

Therefore there is a need for a more effective method of protecting data stored in mobile devices.

### SUMMARY

In one embodiment, confidential data items stored in a computing device are encrypted using content-encryption keys that are not present in the device while the device is locked. When a user unlocks the device, the content-encryption keys are computed using one or more externally stored keys entrusted to key storage services, as well as secrets supplied by the user such as a PIN and/or a biometric sample, secrets stored in the device, and an optional hardware key. When several externally stored keys are available, a subset of them are combined using a secret sharing technique. To retrieve an externally stored key, the device authenticates to a key storage service using a credential that is not stored in the device while the device is locked. The credential is instead regenerated from a protocredential and the secrets supplied by the user.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. Reference numerals consist of a concatenation of a one- or two-digit number referring to a figure, followed by a two-digit number that locates the referenced part within the figure. A reference numeral introduced in a figure may be used in other figures to refer to the same part or a similar part.

FIG. 1 is a block diagram illustrating a system for protecting confidential data using a content-encryption key stored in external storage provided by a key storage service.

FIG. 2 is a block diagram illustrating a system for protecting confidential data using content-encryption keys computed from an externally stored key.

FIG. 3 is a block diagram illustrating a system for protecting confidential data using content-encryption keys computed from several externally stored keys using Shamir Secret Sharing.

FIG. 4 is a block diagram illustrating a system for protecting confidential data using content-encryption keys computed from several externally stored keys using Shamir Secret Sharing, and from a hardware key.

FIG. 5 is a block diagram illustrating several kinds of key storage services.

FIG. 6 is a block diagram illustrating a key storage service containing a stored-key record.

FIG. 7 is a dataflow diagram illustrating the computation of content-encryption keys from non-stored secrets and externally stored keys.

FIG. 8 is a dataflow diagram illustrating the computation of content-encryption keys from non-stored secrets, externally stored keys, and a hardware key.

FIG. 9 is a dataflow diagram illustrating contents of a storage subsystem related to the computation of content-encryption keys.

FIG. 10 is a flow diagram illustrating a process for computing content-encryption keys.

FIG. 11 is a block diagram illustrating non-stored secrets consisting of a passcode.

FIG. 12 is a block diagram illustrating derivation parameters related to non-stored secrets consisting of a passcode.

FIG. 13 is a flow diagram illustrating a subprocess for computing a derived key from non-stored secrets consisting of a passcode.

FIG. 14 is a block diagram illustrating non-stored secrets consisting of a biometric sample.

FIG. 15 is a block diagram illustrating derivation parameters related to non-stored secrets consisting of a biometric sample.

FIG. 16 is a flow diagram illustrating a subprocess for computing a derived key from non-stored secrets consisting of a biometric sample.

FIG. 17 is a block diagram illustrating non-stored secrets consisting of a biometric sample and a passcode.

FIG. 18 is a block diagram illustrating derivation parameters related to non-stored secrets consisting of a biometric sample and a passcode.

FIG. 19 is a flow diagram illustrating a subprocess for computing a derived key from non-stored secrets consisting of a biometric sample and a passcode.

FIG. 20 is a flow diagram illustrating a subprocess for computing a derived key from a hardware key and non-stored secrets consisting of a passcode using a key derivation function implemented in a cryptographic module.

FIG. 21 is a flow diagram illustrating a subprocess for computing a derived key from a hardware key and non-stored secrets consisting of a biometric sample using a key derivation function implemented in a cryptographic module.

FIG. 22 is a flow diagram illustrating a subprocess for computing a derived key from a hardware key and non-stored secrets consisting of a biometric sample and a passcode using a key derivation function implemented in a cryptographic module.

FIG. 23 is a block diagram illustrating a computing device equipped with a cryptographic module that implements the AES encryption algorithm.

FIG. 24 is a flow diagram illustrating a subprocess for computing a derived key from a hardware key and non-stored secrets consisting of a passcode using the AES encryption algorithm implemented in a cryptographic module.

FIG. 25 is a flow diagram illustrating a subprocess for computing a derived key from a hardware key and non-stored secrets consisting of a biometric sample using the AES encryption algorithm implemented in a cryptographic module.

FIG. 26 is a flow diagram illustrating a subprocess for computing a derived key from a hardware key and non-stored secrets consisting of a biometric sample and a passcode using the AES encryption algorithm implemented in a cryptographic module.

FIG. 27 is a flow diagram illustrating a subprocess for retrieving an externally stored key from a key storage service.

FIG. 28 is a flow diagram illustrating a process for setting up a system for protecting confidential data.

FIG. 29 is a flow diagram illustrating a process for erasing plaintext context-encryption keys and other data when a user locks a computing device.

FIG. 30 is a flow diagram illustrating a process for updating a system that protects confidential data when a user submits new reference non-stored secrets.

FIG. 31 is a block diagram illustrating a key pair pertaining to the DSA cryptosystem.

FIG. 32 is a block diagram illustrating a credential comprising a DSA key pair.

FIG. 33 is a block diagram illustrating a protocredential that can be used in conjunction with non-stored secrets to regenerate a credential comprising a DSA key pair.

FIG. 34 is a flow diagram illustrating a subprocess for generating a credential and a protocredential from non-stored secrets.

FIG. 35 is a flow diagram illustrating a subprocess for regenerating a credential from a protocredential and non-stored secrets.

FIG. 36 is a block diagram illustrating supplemental parameters related to non-stored secrets consisting of a passcode.

FIG. 37 is a flow diagram illustrating a subprocess for generating supplemental parameters and a key-pair regeneration key from non-stored secrets consisting of a passcode.

FIG. 38 is a flow diagram illustrating a subprocess for computing a key-pair regeneration key from supplemental parameters and non-stored secrets consisting of a passcode.

FIG. 39 is a block diagram illustrating supplemental parameters related to non-stored secrets consisting of a biometric sample.

FIG. 40 is a flow diagram illustrating a subprocess for generating supplemental parameters and a key-pair regeneration key from non-stored secrets consisting of a biometric sample.

FIG. 41 is a flow diagram illustrating a subprocess for computing a key-pair regeneration key from supplemental parameters and non-stored secrets consisting of a biometric sample.

FIG. 42 is a block diagram illustrating supplemental parameters related to non-stored secrets consisting of a biometric sample and a passcode.

FIG. 43 is a flow diagram illustrating a subprocess for generating supplemental parameters and a key-pair regeneration key from non-stored secrets consisting of a biometric sample and a passcode.

FIG. 44 is a flow diagram illustrating a subprocess for computing a key-pair regeneration key from supplemental parameters and non-stored secrets consisting of a biomatric sample and a passcode.

FIG. 45 is a flow diagram illustrating a subprocess for storing a key at a key storage service and registering credential verification data.

FIG. 46 is a flow diagram illustrating a subprocess for registering credential verification data pertaining to a new credential with a key storage service.

FIG. 47 is a flow diagram illustrating a subprocess for requesting an externally stored key from a key storage service and authenticating the request with a credential.

FIG. 48 is a block diagram illustrating several kinds of encrypted data.

FIG. 49 is a block diagram illustrating data related to an encrypted file stored in a storage subsystem.

FIG. 50 is a flow diagram illustrating a process for creating an encrypted file.

FIG. 51 is a flow diagram illustrating a process for reading an encrypted file.

FIG. 52 is a flow diagram illustrating a process for writing an encrypted file.

### DETAILED DESCRIPTION

This Detailed Description refers to the accompanying drawings, which are a part hereof and illustrate examples of embodiments of the invention. It is to be understood that other embodiments are possible, and that the features of different exemplary embodiments can be combined together unless otherwise stated.

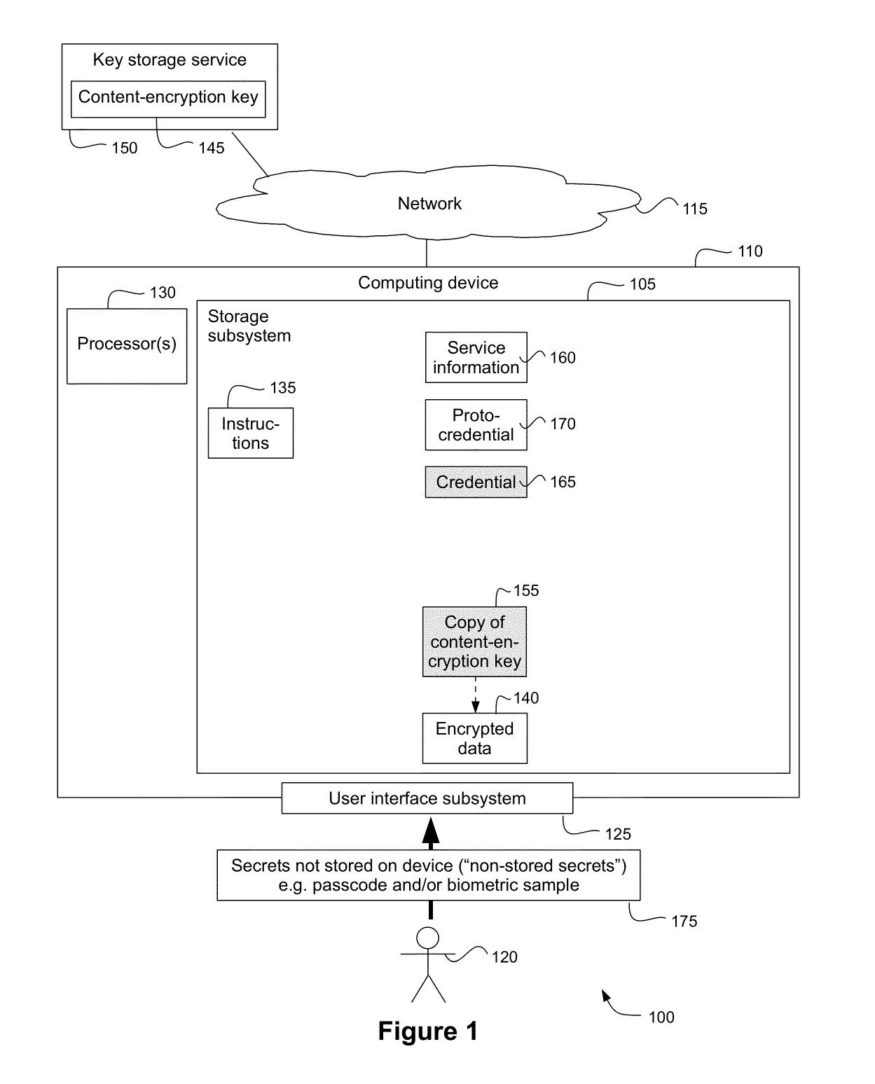

FIG. 1 is a block diagram illustrating a system 100 for protecting confidential data stored in a storage subsystem 105 of a computing device 110 against an adversary who captures the device, according to some embodiments. The storage subsystem comprises one or more storage media such as RAM, ROM, flash memory, magnetic disk and optical disk. The computing device is connected to a network 115 and interacts with a user 120 via a user interface subsystem 125. In some embodiments the computing device 110 is a mobile device such as a smart phone or a tablet, and the user interface subsystem comprises a touch screen built into the device. In other embodiments the computing device is a laptop and the user interface subsystem comprises a keyboard and a track pad built into the device. In yet other embodiments the computing device is a desktop computer and the user interface subsystem comprises a keyboard and a mouse connected to the desktop computer by wired or wireless connections.

The computing device comprises one or more processors 130 and instructions 135 executable on the processor(s) and stored in the storage subsystem. The instructions pertain to one or more programs, including bootstrapping code, an operating system, and applications. The processor(s) follow the instructions to perform computations and to cause the device to interact with the user via the user interface subsystem, with computers connected to the network 115 and with services hosted on such computers or accessible via such computers. In some embodiments the computing device includes a cryptographic module, and the processor(s), following the instructions, may interact with the module and cause cryptographic circuitry in the module to perform computations and return the results of the computations.

An encrypted copy 140 of the confidential data is stored in the storage subsystem. A decryption algorithm is used to decrypt all or part of the data when the data is needed. A corresponding encryption algorithm is used to create the encrypted copy of the data, and to reencrypt the data after it has been decrypted and modified. In some embodiments the encryption and decryption algorithms are those specified in the Advanced Encryption Standard (AES), publication FIPS PUB-197 of the National Institute of Standards and Technology (NIST), used according to one of the modes of operation specified in NIST publications SP 800-38A, SP 800-38A Addendum, SP 800-38C, SP 800-38D and SP 800-38E. A symmetric content-encryption key 145 is used for both encryption and decryption. The size of the content-encryption key is 128, 192 or 256 bits, i.e. 16, 24 or 32 bytes respectively, in various embodiments.

To protect the content-encryption key against an adversary who captures the device, the content-encryption key is stored outside the device, in external storage provided by a key storage service 150 accessible via the network 115. The user can put the device in a locked state or an unlocked state. A copy 155 of the content-encryption key is retrieved from the key storage service when the user unlocks the device and then is stored in the storage subsystem 105. The copy is erased when the user locks the device. (“Erasing” data means herein overwriting the data with other data, such as zero bytes.)

The dashed-line arrow from the copy 155 of the content-encryption key to the encrypted copy 140 of the confidential data is meant to illustrate the fact that the copy of the content-encryption key is used to decrypt and reencrypt the confidential data as needed while the device is unlocked.

The box 155 representing the copy of the encrypted data has a grey background to illustrate the fact that the copy of the content-encryption key is not present in the storage subsystem when the device is in the locked state. The copy is thus protected against an adversary who captures the device when it is in the locked state. (In other embodiments there is no distinction between a locked state and an unlocked state, but the copy of the content-encryption key is only brought into the storage subsystem when needed, and is erased from the storage subsystem when it is no longer needed, so that it is only present temporarily in the device, and is thus protected against an adversary who captures the device when the copy is not present in the device.)

To retrieve the externally stored content-encryption key, the device makes an authenticated request to the key storage service over a secure connection. Information 160 about the key storage service used to establish the secure connection is stored in the storage subsystem 105.

The request is authenticated using a credential 165. To protect the credential against an adversary who captures the device, the credential is not permanently stored in the device. The credential is generated and registered with the key storage service at the time when the content-encryption key is entrusted to the key storage service. A protocredential 170 is generated concurrently with the credential, and the credential is discarded after use. (A “protocredential” is a data structure stored in the device that can be used to produce a credential when combined with one or more secrets not stored on the device.) Later, when the user unlocks the device and the content-encryption key must be retrieved from the key storage service, the credential is regenerated from the protocredential and a set of one or more secrets 175 not stored in the device (the “non- stored secrets”). The credential is then used to retrieve the content-encryption key, and discarded again.

In the embodiments illustrated by FIG. 1 the non-stored secrets are supplied by the user. In some embodiments the set of non-stored secrets consists of a single passcode, such as as a personal identification number (PIN), a password, or a passphrase. In other embodiments the set consists of a biometric sample. In other embodiments the set consists of a passcode and a biometric sample. In embodiments alternative to those of FIG. 1, some of the non-stored secrets are not supplied by the user. In some embodiments a non-stored secret not supplied by the user is the output of a physical unclonable function (PUF).

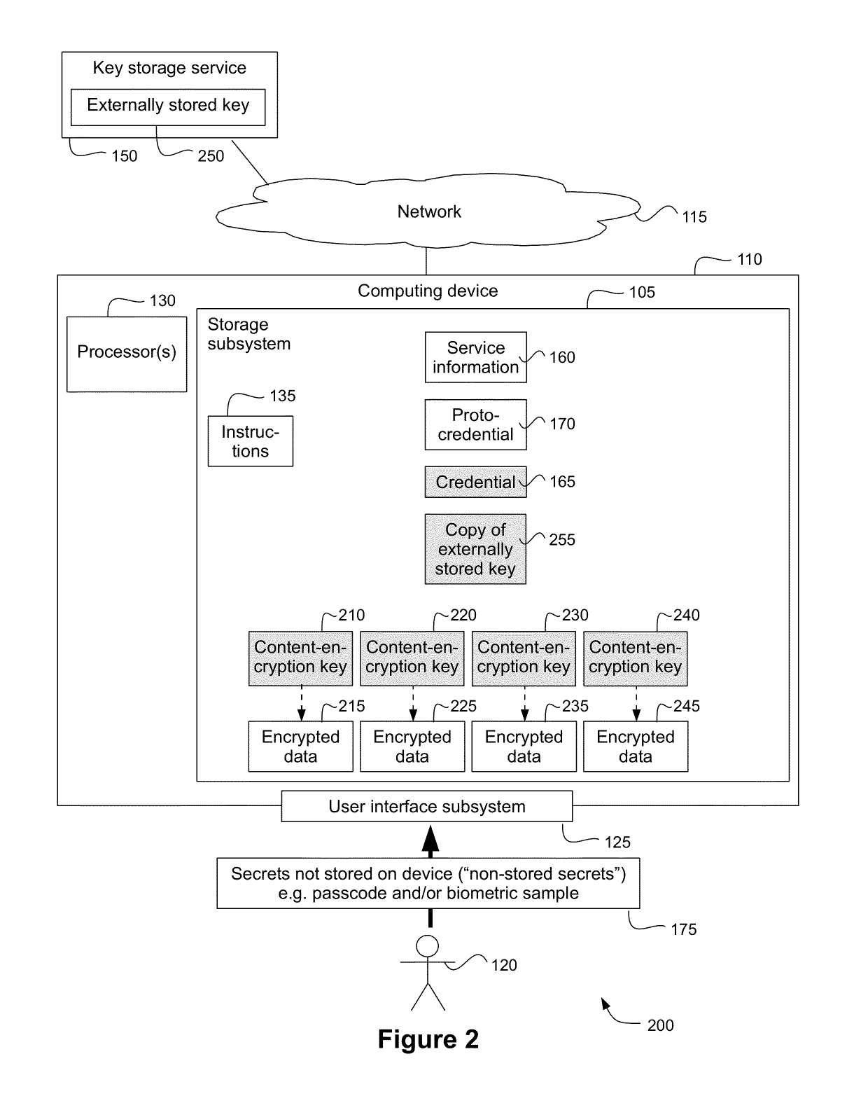

FIG. 2 is a block diagram illustrating a system 200 for protecting confidential data according to some embodiments that make use of one or more content-encryption keys. Four such keys 210, 220, 230, 240 are shown in the figure as an example. The size of each content-encryption key is 128, 192 or 256 bits, i.e. 16, 24 or 32 bytes respectively, in various embodiments where the Advanced Encryption Standard (AES) referenced above is used for encryption and decryption of the confidential data. The four content-encryption keys are stored in the clear in the storage subsystem 105 while the device is in the unlocked state, and are used to decrypt and reencrypt as needed four encrypted items of confidential data 215, 225, 235, 245; as in FIG. 1, this is illustrated by dashed-line arrows from the boxes representing the content-encryption keys to the boxes representing the encrypted confidential data items. The key storage service 150 contains an externally stored key 250. In some embodiments, the size of the externally stored key is 256 bits, i.e. 32 bytes. A copy 255 of the externally stored key is brought to the device when the user unlocks the device, kept stored in the storage subsystem while the device is in the unlocked state, and used as input to a computation of the content-encryption keys performed by the processor(s) 130 according to the instructions 135. The content-encryption keys and the copy of the externally stored keys are erased from the device when the user locks the device. As in FIG. 1, and as in all subsequent figures, data items that are not present in the storage subsystem while the device is in the locked state are represented as boxes with grey backgrounds.

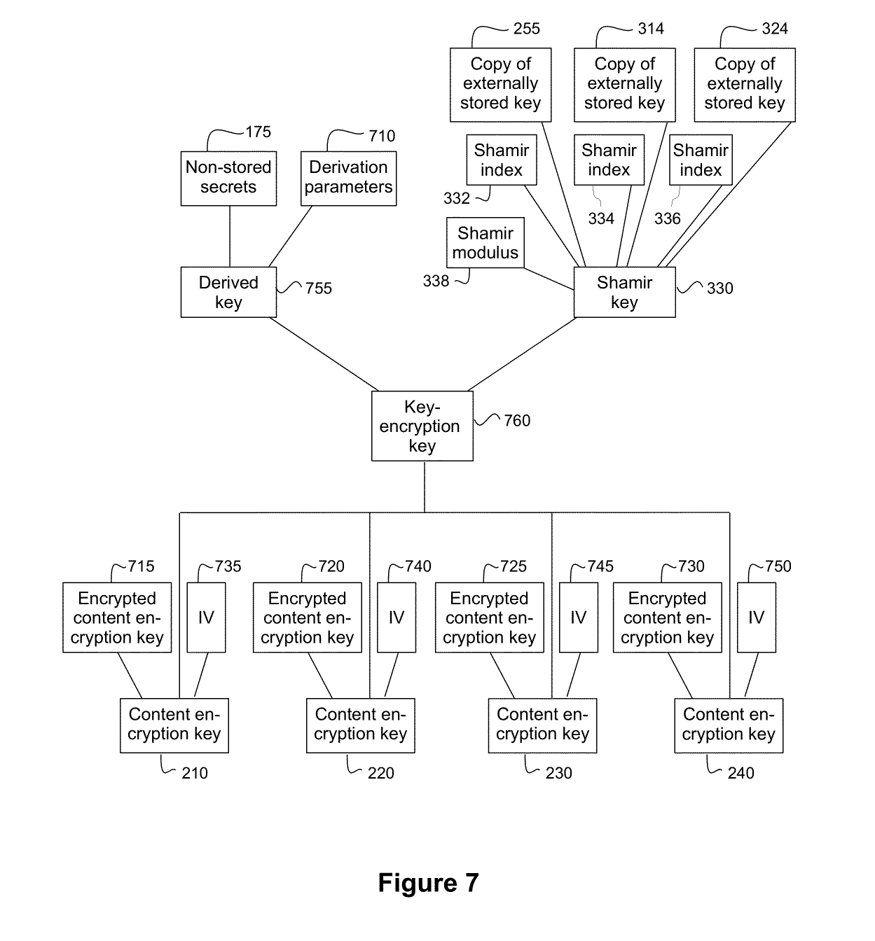

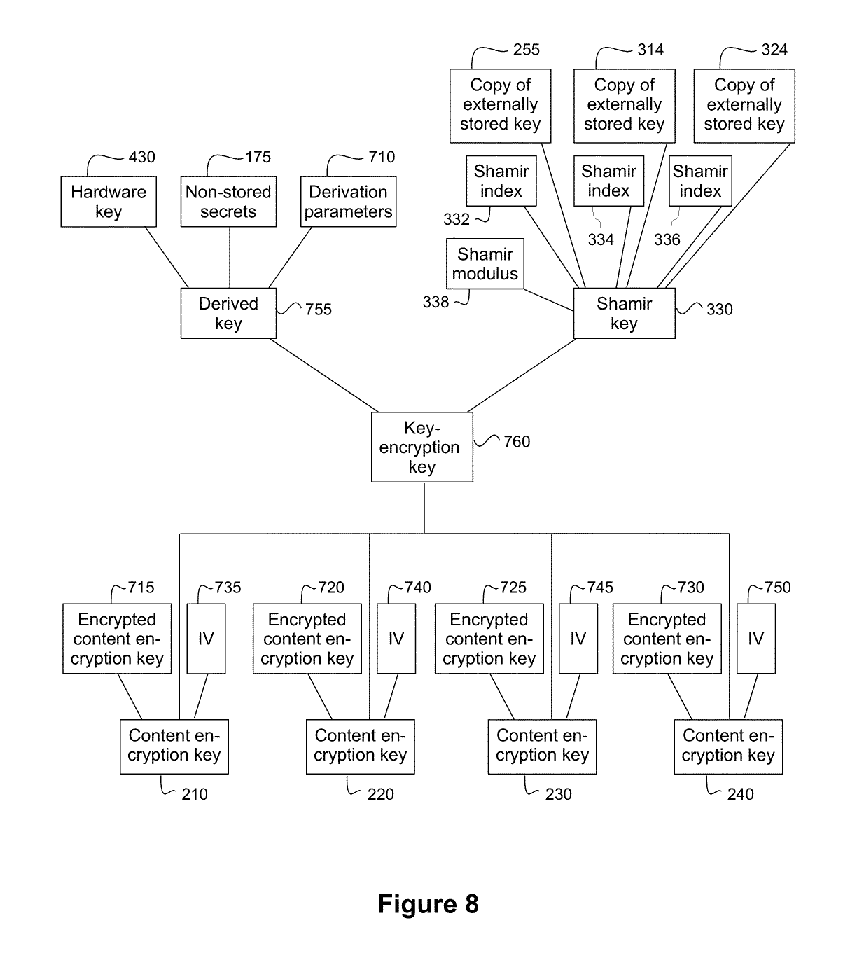

The computation of the content-encryption keys from the externally stored key is performed according to a key hierarchy, such as those illustrated in FIGS. 7 and 8. (The term “key hierarchy” is used herein to refer to a dataflow diagram specifying the computation of one or more keys used in cryptographic algorithms. In the context of a key hierarchy, the term “key” is used broadly to refer both to keys used in cryptographic algorithms, and to data items used as inputs or intermediate results in computations of keys used in cryptographic algorithms.)

To retrieve the copy 255 of the externally stored key 250 from the key storage service 150, the device sends a request to the service over a secure connection established using the service information 160, authenticating the request with the credential 165 regenerated from the protocredential 170 and the non-stored secrets 175 as in FIG. 1. In some embodiments, the non-stored secrets 175 are used as additional inputs to the computation of the content-encryption keys besides being used for the regeneration of the credential used by the device to authenticate to the key storage service and retrieve the externally stored key.

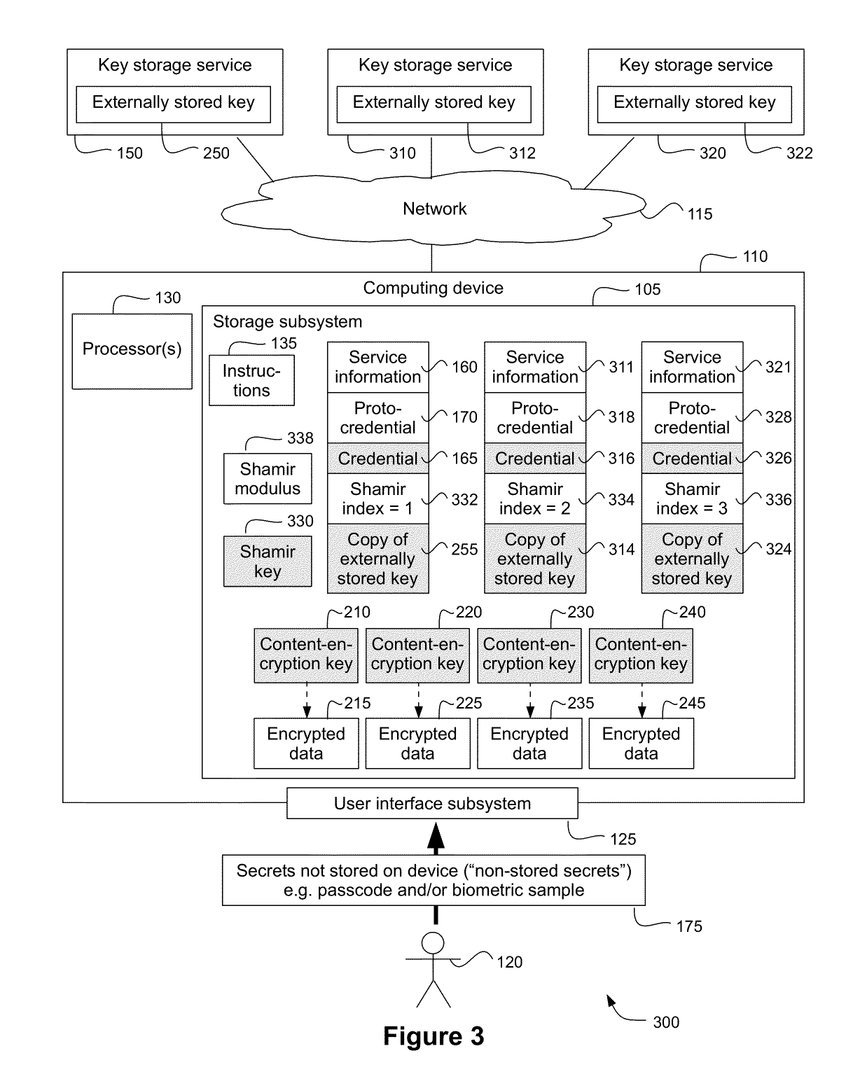

FIG. 3 is a block diagram illustrating a system 300 for protecting confidential data according to embodiments where additional key storage services 310, 320 besides the key storage service 150 of FIG. 2 are used to store additional externally stored keys 312, 322 besides the externally stored key 250 of FIG. 2. Service information 311, 321 used for establishing secure connections to services 310, 320 is stored in the storage subsystem 105.

The three externally stored keys 250, 312 and 322 are used in conjunction with three associated indices 332, 334, 336 and a modulus 338 to compute a key 330 using a secret sharing technique described in the paper “How to Share a Secret” by Adi Shamir, Communications of the ACM Vol. 22 No. 11, November 1979 (“Shamir's paper”). Hereinafter the technique will be called “Shamir Secret Sharing”, the indices 332, 334, 336 will be called “the Shamir indices”, the modulus 338 will be called “the Shamir modulus”, and the key 330 will be called “the Shamir key”.

Shamir Secret Sharing makes it possible to divide a secret D into n shares (called “pieces” in Shamir's paper) in such a way that k shares are sufficient to reconstruct D, but K−1 shares provide no information about D. The modulus is a prime number, denoted “p” in Shamir's paper, the secret and the shares are defined modulo p, and the secret is reconstructed from the shares (and their associated indices) by a polynomial interpolation using arithmetic modulo p. In system 300, the technique is used with n=3 and k=2, i.e. there are three shares, and two of them are sufficient to reconstruct the Shamir key. The three shares are the externally stored keys 250, 312, 322. Their associated indices 332, 334, 336 and the modulus 338 are stored in the storage subsystem 105.

Copies 255, 314, 324 of the externally stored keys 250, 312, 322 are requested in parallel from the key storage services 150, 310, 320 and the Shamir key 330 is computed as soon as two out of the three copies are obtained. The copies are retrieved when the user unlocks the device, kept stored in the storage subsystem 105 while the device remains in the unlocked state, and erased from the storage subsystem when the user locks the device. To retrieve the copies, the device sends requests to the key storage services over secure connections established using service information 160, 311, 321, authenticating the requests by using credentials 165, 316, 326 regenerated from protocredentials 170, 318, 328 and the non-stored secrets 175. The same set of non-stored secrets are used to regenerate all three credentials, so that the user does not have to enter multiple sets of non-stored secrets. The device authenticates to the key storage service 150 using the credential 165 and the set of non-stored secrets 175 as in FIGS. 1 and 2. It authenticates to the key storage service 310 using the credential 316 and the same set of non-stored secrets 175, and to the key storage service 320 using the credential 326 and the same set of non-stored secrets 175.

After the Shamir key has been computed, it is used as an input to the computation of the content-encryption keys 210, 220, 230 and 240; in some embodiments, the non- stored secrets 175 are also used as inputs to the computation. The Shamir key is not present in the device when the device is in the locked state; hence it is represented in the figure as a box with a grey background. In some embodiments the Shamir key is erased from the storage subsystem immediately after it has been used to compute the content-encryption keys. In other embodiments it is kept in the storage subsystem while the device is unlocked, then erased when the user locks the device.

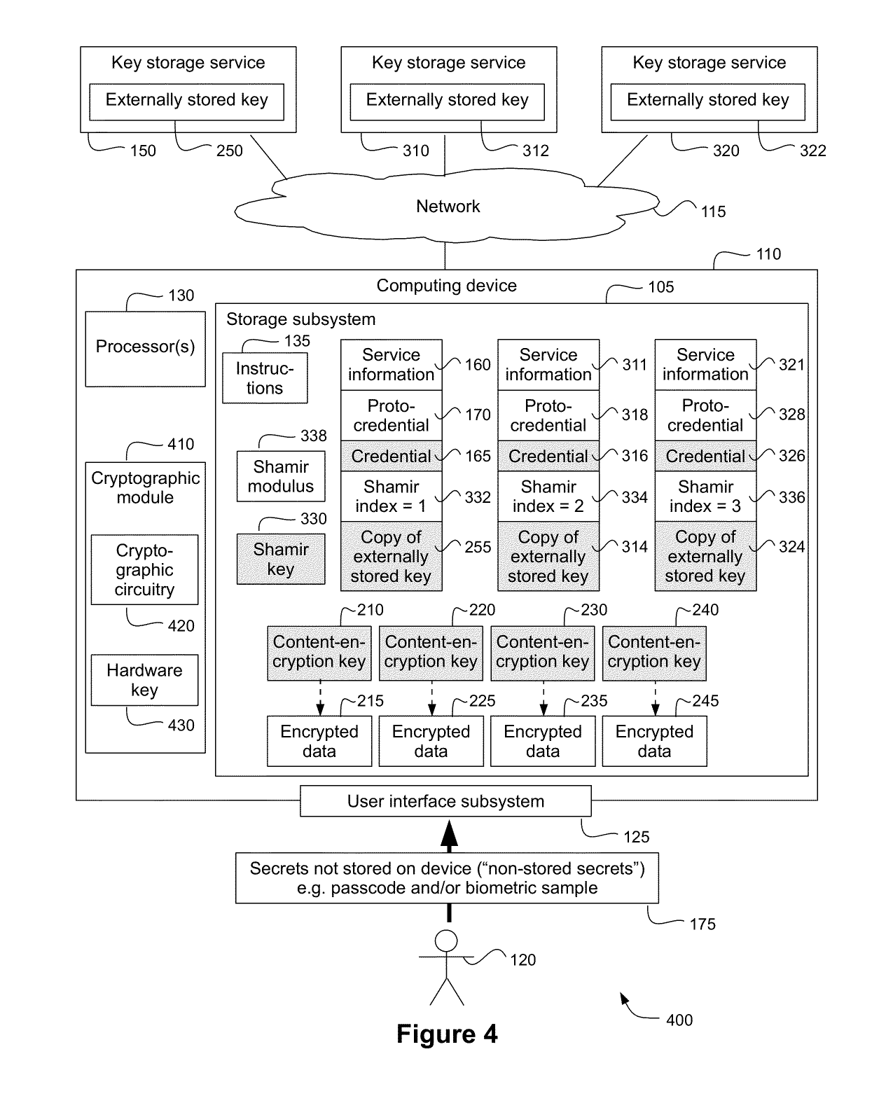

FIG. 4 is a block diagram illustrating a system 400 for protecting confidential data according to embodiments where the computing device 110 comprises a cryptographic hardware module 410, implemented as a chip containing cryptographic circuitry 420 and a key 430. The module exposes an interface through which the processor(s) 130 can ask the module to perform computations using the key 430, but cannot ask the module to export the key, at least not in plaintext form. (In some embodiments the key 430 can be exported encrypted under a key-encryption key built into the hardware module.) The term “hardware key” will be used henceforth to refer to a key contained in a hardware cryptographic module that cannot be exported from the module in plaintext form. The key 430 is thus a hardware key.

The computation of the content-encryption keys 210, 220, 230 and 240 takes as input the hardware key 430 in addition to the copies 255, 314, 324 of the externally stored keys 250, 312, 322 and, in some embodiments, in addition to the non-stored secrets 175. Since the hardware key 430 is not exportable, portions of the computation involving the hardware key are performed by the cryptographic circuitry 420.

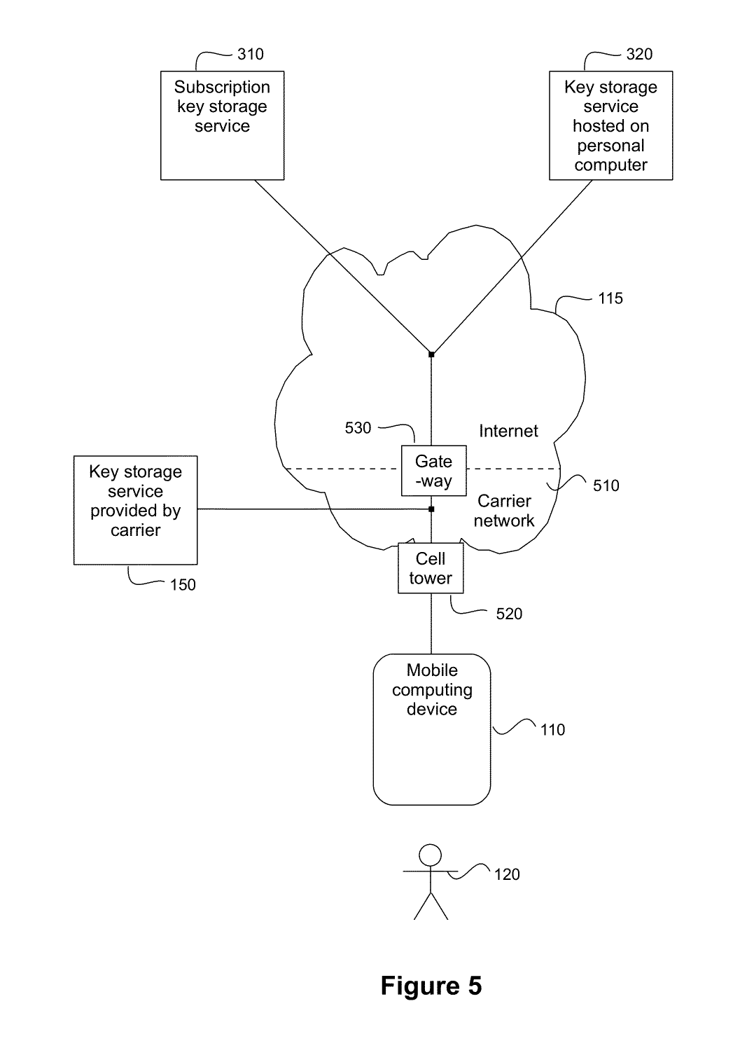

FIG. 5 is a block diagram illustrating some embodiments that make use of different kinds of key storage services. Network 115 is the Internet and the computing device 110 is connected to the Internet via a carrier network 510 accessed through a cell tower 520. The carrier network carries Internet Protocol (IP) packets from the computing device to an Internet gateway 530, and thus can be seen as a subnet or collection of subnets of the Internet.

The key storage service 150 is provided by the carrier and accessible from the computing device 110 over a carrier network connection established within the carrier network.

The key storage service 310 is provided on a subscription basis on the Internet and accessible from the computing device 110 over a TCP connection.

The key storage service 320 is provided by a personal computer owned by the same user who owns the computing device 110 or by a different user, and accessible from the computing device 110 over a peer-to-peer connection established within a peer-to-peer network overlaid on the Internet.

In some embodiments, when the computing device connects to a key storage service, the connection is secured using the Transport Layer Security (TLS) protocol, specified in the request for comments (RFC) 5246 of the Internet Engineering Task Force (IETF). Thus, when the computing device connects to the key storage service 150 provided by the carrier, it establishes a TLS connection over an underlying carrier network connection; when it connects to the subscription key storage service 310, it establishes a TLS connection over an underlying TCP connection; and when it connects to the key storage service 320 hosted on a personal computer, it establishes a TLS connection over the underlying peer-to-peer connection. The TLS connection protects the confidentiality of the externally stored key entrusted to the service, and allows the service to authenticate to the computing device by means of a certificate.

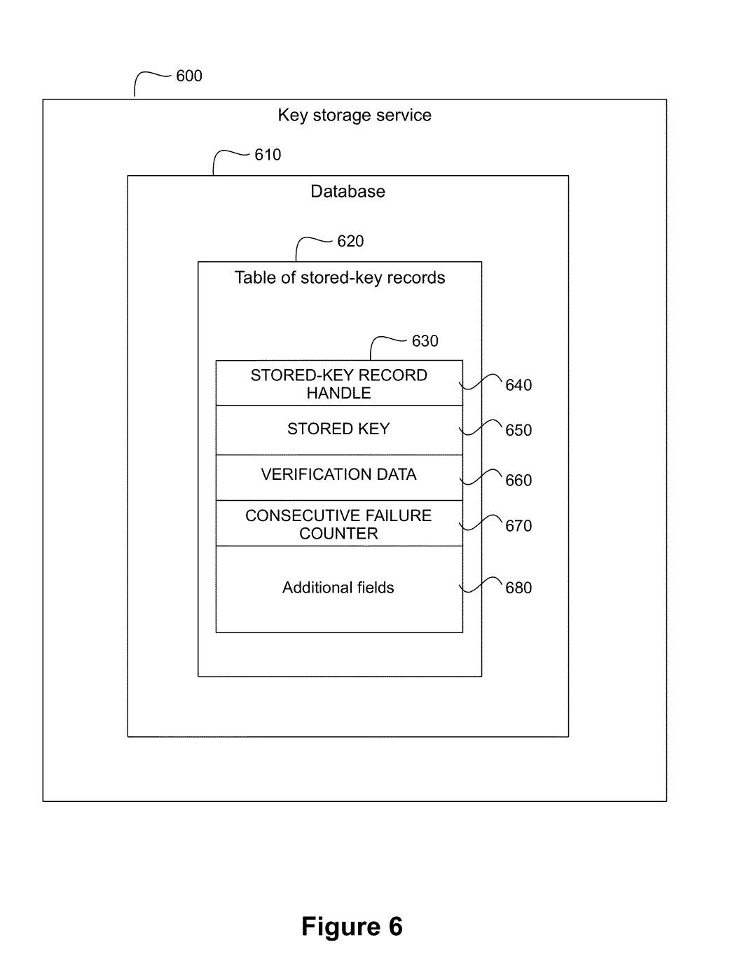

FIG. 6 is a block diagram illustrating a key storage service 600 that can play the role of one of the key storage services 150, 310 and 320 of previous figures. The key storage service 600 contains a database 610, which itself contains a table 620 of stored-key records, each used to store a key entrusted to the key storage service by a computing device 110, such as one of the keys 145, 250, 312 322 of previous figures. Each stored-key record 630 comprises the following fields:
a STORED-KEY RECORD HANDLE field 640 containing a handle that uniquely identifies the record within the table of stored-key records, the term “handle” being used herein as a synonym to the term “primary key” of database terminology to avoid confusion between database keys and cryptographic keys;
a STORED KEY field 650 containing the key stored in the record;
a VERIFICATION DATA field 660 containing data used to verify the credential used by the computing device 110 to make an authenticated request for the key, such as one of the credentials 165, 316, 326 of previous figures;
a CONSECUTIVE FAILURE COUNTER field 670 that is used to count the number of consecutive authentication failures and disable the stored-key record when the count reaches a configured limit; and
additional fields 680.

The additional fields depend on the kind of key storage service. For example, a carrier-provided service such as the service 150 of FIG. 5 may comprise a field containing an identifier used by the carrier to uniquely identify the computing device within the carrier network; a subscription service such as the service 310 of FIG. 5 may comprise a field referring to a subscription account; and a service hosted on a personal computer may comprise a field containing a nickname by which the owner of the personal computer refers to the computing device 110.

FIG. 7 is a key hierarchy 700 illustrating the computation of the content-encryption keys 210, 220, 230, 240 of system 300 that takes place when the user unlocks the computing device 110, according to embodiments where the set of non-stored secrets 175 is used both for the regeneration of credentials 165, 316, 326 from the protocredentials 170, 318, 328 and as an input to the computation.

The computation takes as inputs the non-stored secrets 175, derivation parameters 710, which are considered secrets, the copies of the externally stored keys 255, 314, 324 together with their associated Shamir indices 332, 334, 336 and Shamir modulus 338, encrypted forms 715, 720, 725, 730 of the content-encryption keys, and initialization vectors (IVs) 735, 740, 745, 750. (The derivation parameters are used in the computation of a derived key 755. The term “derived key” is used herein to refer to a key computed from inputs comprising one or more non-stored secrets using a key derivation function. The term “derivation parameters” is used to refer to inputs other than non-stored secrets used in the computation of a derived key.)

In some embodiments the non-stored secrets consist of a single passcode and the derivation parameters consist of a salt. (The term “salt” is used herein to refer to a random string used as an additional input to a one-way function such as a hash function or a key derivation function. The term “random string” refers to a string generated at random. The concept of “generation at random” is to be understood broadly as referring to generation by a true random bit generator, by a pseudo-random bit generator, or by an entropy accumulator such as the /dev/urandom facility of Linux and other Unix systems.)

In other embodiments the non-stored secrets consist of a biometric sample, or both a biometric sample and a passcode, and the derivation parameters consist of a salt and auxiliary data used to compute a biometric key from the biometric sample. Several biometric key generation methods have been described in the biometric authentication literature for computing a biometric key from a biometric sample and auxiliary data (also called helper data). At setup time, the user provides a reference biometric sample, which is used to generate the biometric key and the auxiliary data. (In some methods the biometric key is independent of the sample.) Later, the user provides an authentication sample, and the biometric key is computed from the authentication sample and the auxiliary data. The biometric key computed from the authentication sample is the same as the biometric key generated at setup time with moderately high probability even though the authentication sample is not identical to the reference sample, as long as the authentication sample is genuine. One biometric key generation method is described in the Technical Report Number 640 of the Computer Laboratory of the University of Cambridge, entitled “Combining cryptography with biometrics effectively”, by Feng Hao, Ross Anderson and John Daugman, dated July 2005. References to other biometric key generation methods can be found in Sections 3.3 and 3.4 of the review article entitled “Biometric Template Security”, by Anil K. Jain, Karthik Nandakumar and Abhishek Nagar, in the EURASIP Journal on Advances in Signal Processing, Volume 2008, Article ID 579416.

The derived key 755, the Shamir key 330 and a key-encryption key 760 are intermediate results of the computation. The derived key is computed from the non-stored secrets 175 and the derivation parameters 710 using a key derivation function. In all embodiments considered, the size of the derived key is 256 bits, i.e. 32 bytes, although other sizes may be used in alternative environments. The Shamir key is computed from two of the three externally stored keys using the Shamir secret sharing technique. The key-encryption key is computed from the derived key and the Shamir key using a hash function. Each content-encryption key is computed by decrypting the encrypted form of the content-encryption key using the key-encryption key and a corresponding initialization vector.

FIG. 8 is a key hierarchy 800, similar to the key hierarchy 700, illustrating the computation of the content-encryption keys 210, 220, 230, 240 of system 400 that takes place when the user unlocks the computing device 110, according to embodiments where the set of non-stored secrets 175 is used both for the regeneration of credentials 165, 316, 326 from the protocredentials 170, 318, 328 and as an input to the computation. It differs from FIG. 7 in that the hardware key 430 is an additional input to the computation of the derived key 755.

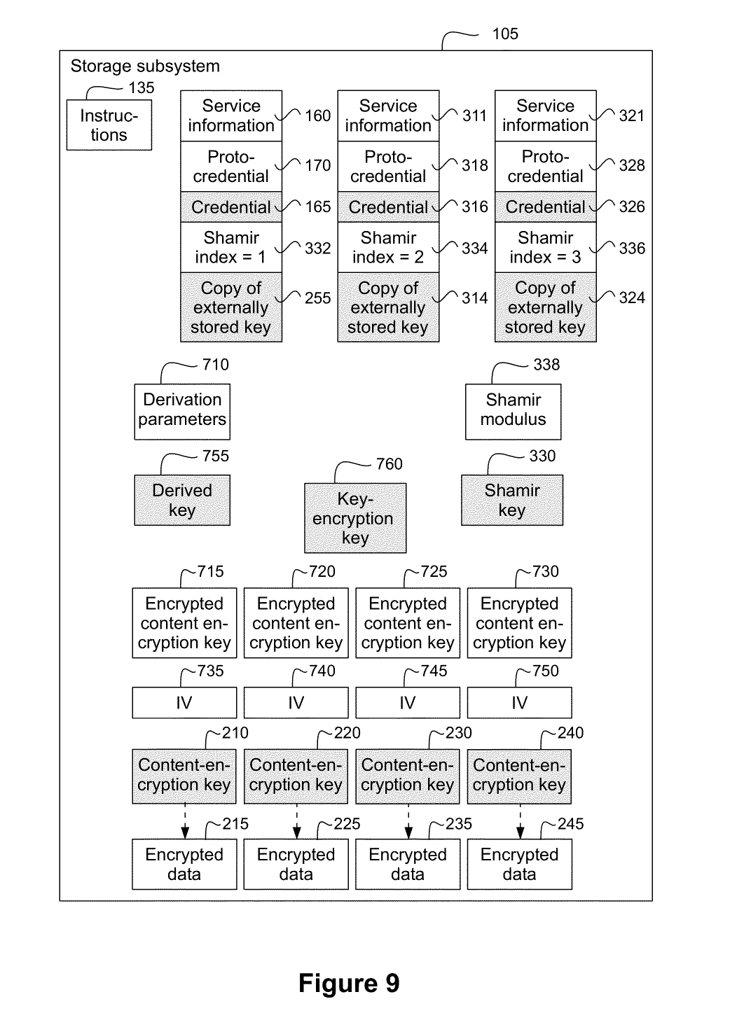

FIG. 9 is a block diagram illustrating additional contents of the storage subsystem 105 of system 300 or 400 related to the computation of the content-encryption keys 210, 220, 230, 240, according to embodiments where the content-encryption keys are computed according to the key hierarchies 700 or 800 respectively. As in FIGS. 1-4, boxes with a grey background represent data that is not present in the storage subsystem while the device is locked. In addition to the data items shown in FIGS. 3 and 4, the storage subsystem contains the derivation parameters 710, the derived key 755, the key-encryption key 760, the encrypted forms 715, 720, 725, 730 of the content-encryption keys, and the corresponding initialization vectors (IVs) 735, 740, 745, 750.

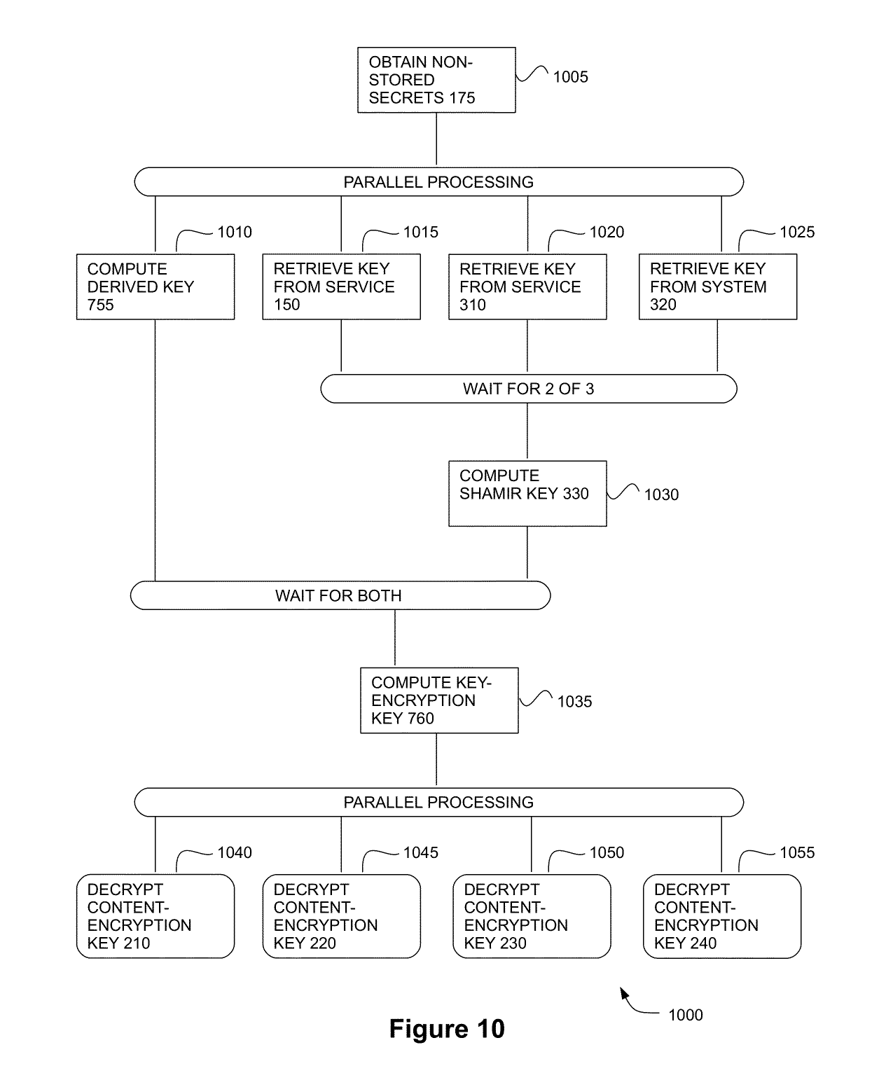

FIG. 10 is a flow diagram illustrating a process 1000 followed by the computing device 110 when the user unlocks the device, for performing the computation of the content-encryption keys 210, 220, 230, 240, the computation being performed as specified by the key hierarchy 700, or, in embodiments where the computing device is equipped with the cryptographic module 410 containing a hardware key 430, as specified by the key hierarchy 800.

The process 1000 is a parallel process. In embodiments where the computing device has more than one processor(s) 130, some parallelism may be achieved by having multiple processors execute instructions 135 simultaneously. Whether or not there are more than one processors 130, some parallelism may be achieved by interleaving several threads of execution on one processor; for example, after requesting an externally stored key from a key storage service, a processor may switch to a different thread of execution while waiting for delivery of the key. In embodiments where the computing device is equipped with a cryptographic module 410, some parallelism may also be achieved by having one or more processors 130 execute instructions 135 while the cryptographic module is performing cryptographic computations. (When no parallelism can be achieved between threads specified as being parallel, those threads are performed sequentially, the order in which they are executed being immaterial.)

The parallel process 1000 begins with step 1005.

At 1005 the device obtains the one or more non-stored secrets 175 from the user 120 via the user interface subsystem 125.

Steps 1010, 1015, 1020 and 1025 are initiated in parallel once step 1005 has been completed.

At 1010 the device computes the derived key 755. In some embodiments where the computing device is not equipped with a cryptographic module, the derived key is computed from the non-stored secrets 175 and the derivation parameters 710. In some embodiments where the computing device is equipped with the cryptographic module 410, the derived key is computed from the hardware key 430, the non-stored secrets 175 and the derivation parameters 710. Subprocesses for performing step 1010 are described below and illustrated in FIGS. 13, 16, 19, 20, 21, 22, 24, 25 and 26.

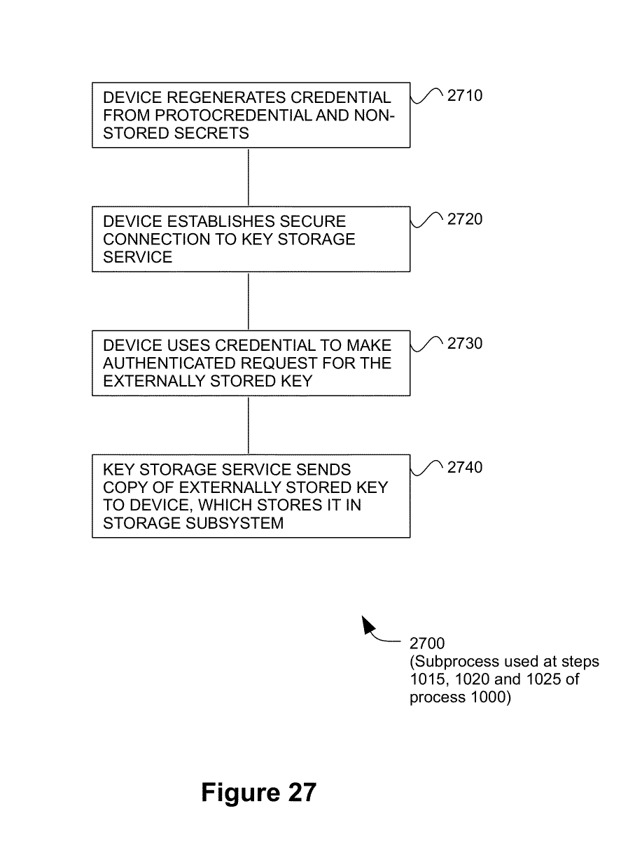

At 1015 the device retrieves the copy 255 of the externally stored key 250 from the key storage service 150. Similarly, at steps 1020, 1025 the device retrieves the copies 314, 324 of the externally stored keys 312, 322 from the key storage services 310, 320. A subprocess for performing steps 1015, 1020 and 1025 is described below and illustrated in FIG. 27.

Step 1030 is initiated once two of the steps 1015, 1020 and 1025 have been completed.

At 1030, the device computes the Shamir key 330 from two of the copies 255, 314, 324 of the externally stored keys 250, 312, 314, the corresponding Shamir indices 332, 334, 336 , and the Shamir modulus 338 using the Shamir Secret Sharing technique referenced above.

Step 1035 is initiated once both steps 1010 and 1030 have been completed.

At 1035 the device computes the key-encryption key 760 by hashing the concatenation of the derived key 755 and the Shamir key 330 using a cryptographic hash function. In some embodiments the hash function is the SHA-256 hash function specified in NIST publication FIPS PUB 180-4, and the size of the key-encryption key is 256 bits. (A hash computed by applying the SHA-256 function to a string will henceforth be referred to as “the SHA-256 hash” of the string.)

Steps 1040, 1045, 1050 and 1055 are initiated in parallel once step 1035 has been completed.

At step 1040 the content-encryption key 210 is computed by decrypting the ciphertext 715 with the decryption algorithm specified in the AES (NIST publication FIPS PUB-197), operated in CBC mode (NIST publication SP 800-38A), using the key-encryption key 760 and the initialization vector 735.

Similarly, at steps 1045, 1050, 1055 the content-encryption keys 220, 230, 240 are computed by decrypting the ciphertexts 720, 725, 730 with the decryption algorithm specified in the AES, operated in CBC mode, using the key-encryption key 760 and the initialization vectors 740, 745, 750.

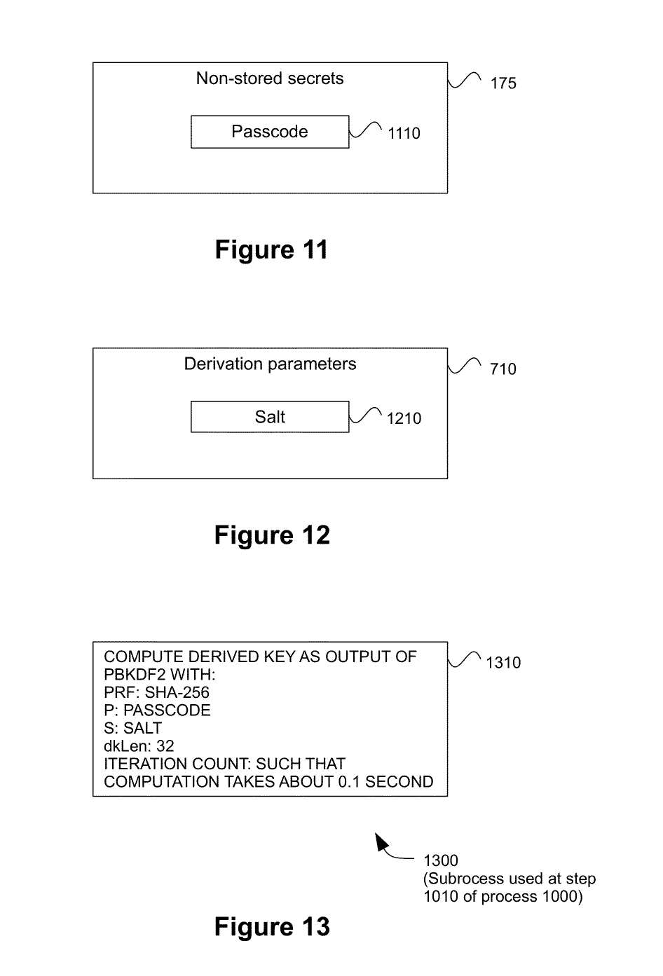

FIGS. 11, 12 and 13 illustrate the computation of the derived key 755, according to some embodiments where the non-stored secrets consist of a passcode, such as a PIN or a password.

FIG. 11 is a block diagram illustrating the non-stored secrets 175 consisting of a passcode 1110.

FIG. 12 is a block diagram illustrating the derivation parameters 710, which consist of a salt 1210.

FIG. 13 is a flow diagram illustrating a subprocess 1300 that takes place at step 1010 of process 1000 for computing the derived key. The subprocess consists of a single step 1310. In other words, step 1310 is a more specific version of the step 1010 of FIG. 10.

At step 1310 the derived key is computed using the key derivation function PBKDF2 specified in Section 5.2 of RFC 2898 of the IETF, using the hash function SHA-256 as the underlying pseudo-random function (PRF). (Other PRFs may be used in alternative embodiments.) With the notations of Section 5.2 of RFC 2898, the value of the argument “P” is the passcode 1110, the value of the argument “S” is the salt 1210, the value of the argument “dkLen” is 32 (so as to produce 32×8=256 bits of output) and the iteration count is chosen based on the speed of the processor(s) 130 so that the time it takes to perform the PBKDF2 computation is about 0.1 second; other choices of the iteration count may be made in alternative embodiments depending on security requirements.

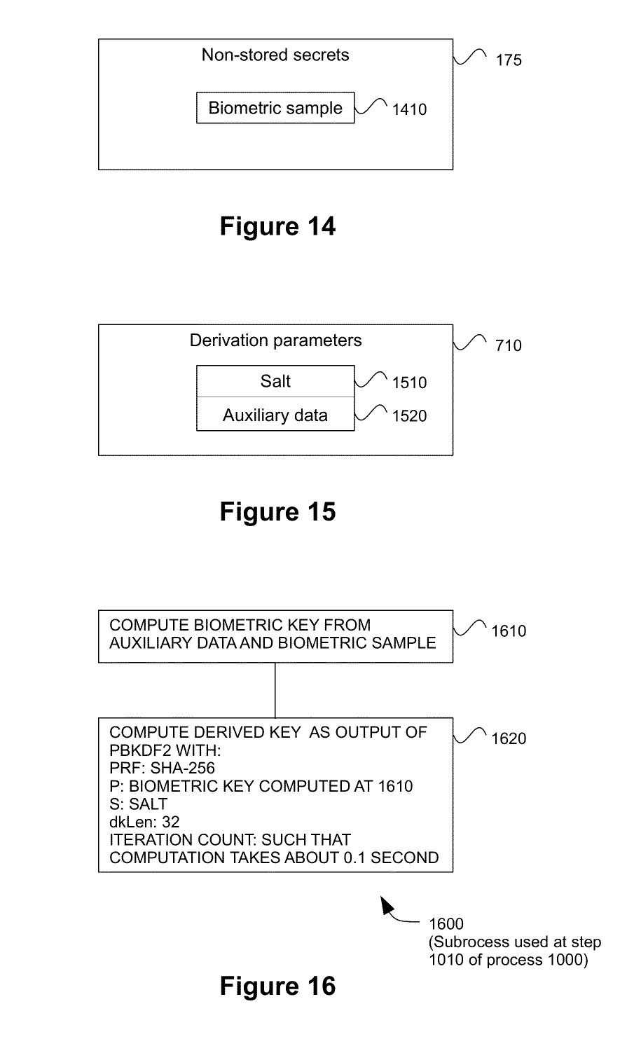

FIGS. 14, 15 and 16 illustrate the computation of the derived key 755, according to some embodiments where the non-stored secrets consist of a biometric sample.

FIG. 14 is a block diagram illustrating the non-stored secrets 175 consisting of a biometric sample 1410.

FIG. 15 is a block diagram illustrating the derivation parameters 710, which consist of a salt 1510, and auxiliary data 1520 used to compute a biometric key from the biometric sample.

FIG. 16 is a flow diagram illustrating a subprocess 1600 that takes place at step 1010 of process 1000 for computing the derived key.

At 1610 a biometric key is computed from the auxiliary data 1520 and the biometric sample 1410. Then the subprocess continues at 1620.

At 1620 the derived key is computed using PBKDF2 with SHA-256 as PRF, the biometric key computed at step 1610 as the value of “P”, the salt 1510 as the value of “S”, 32 as the value of “dkLen”, and an iteration count such that the time it takes to perform the PBKDF2 computation is about 0.1 second. Then the subprocess terminates.

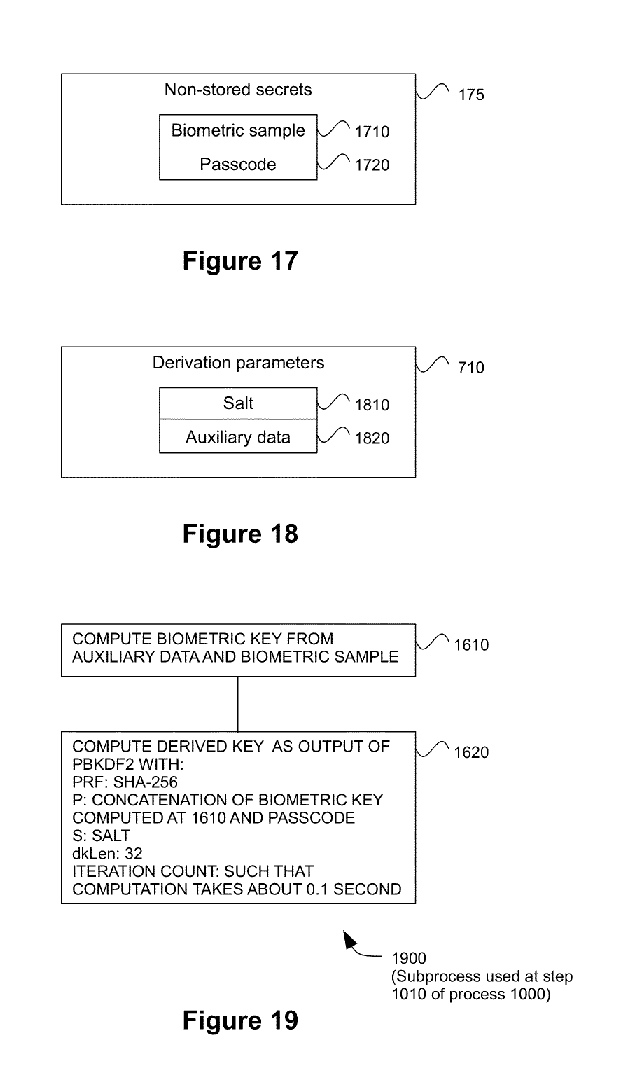

FIGS. 17, 18 and 19 illustrate the computation of the derived key 755, according to some embodiments where the non-stored secrets consist of a biometric sample and a passcode.

FIG. 17 is a block diagram illustrating the non-stored secrets 175 consisting of a biometric sample 1710 and a passcode 1720.

FIG. 18 is a block diagram illustrating the derivation parameters 710, which consist of a salt 1810, and auxiliary data 1820 used to compute a biometric key from the biometric sample.

FIG. 19 is a flow diagram illustrating a subprocess 1900 that takes place at step 1010 of process 1000 for computing the derived key.

At 1910 a biometric key is computed from the auxiliary data 1820 and the biometric sample 1710. Then the subprocess continues at 1920.

At 1920 the derived key is computed using PBKDF2 with SHA-256 as PRF, the concatenation of the biometric key computed at step 1910 and the passcode 1720 as the value of “P”, the salt 1810 as the value of “S”, 32 as the value of “dkLen”, and an iteration count such that the time it takes to perform the PBKDF2 computation is about 0.1 second. Then the subprocess terminates.

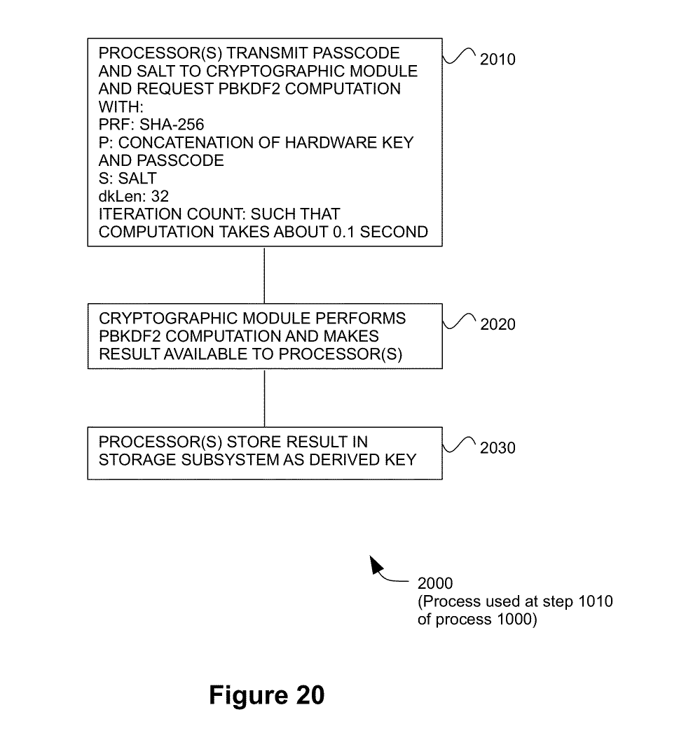

FIG. 20 is a flow diagram illustrating a subprocess 2000 that takes place at step 1010 of process 1000 for computing the derived key 755, according to some embodiments where the computing device 110 is equipped with the cryptographic module 410 and the circuitry 420 in the module includes a hardware implementation of the PBKDF2 key derivation function. The non-stored secrets 175 consist of a passcode 1110 as in FIG. 11 and the derivation parameters 710 consist of a salt 1210 a as in FIG. 12.

At 2010 the processor(s) 130 transmit the passcode 1110 and the salt 1210 to the module and instruct the module to apply the perform a PBKDF2 computation with:
SHA-256 as the PRF;
the concatenation of the hardware key 430 and the passcode as the value of the argument “P”, the hardware key being present in the module, and the module having circuitry to perform the concatenation and use it as the value of “P”;
the salt 1210 as the value of the argument “S”;
32 as the value of the argument “dkLen”; and
an iteration count specified by the processor(s) so that the computation takes about 0.1 second. Then the subprocess continues at 2020.

At 2020 the module performs the requested computation and makes the result available to the processor(s). Then the subprocess continues at 2030.

At 2030 the processor(s) store the result of the computation in the storage subsystem 105 as the value of the derived key 755. Then the subprocess terminates.

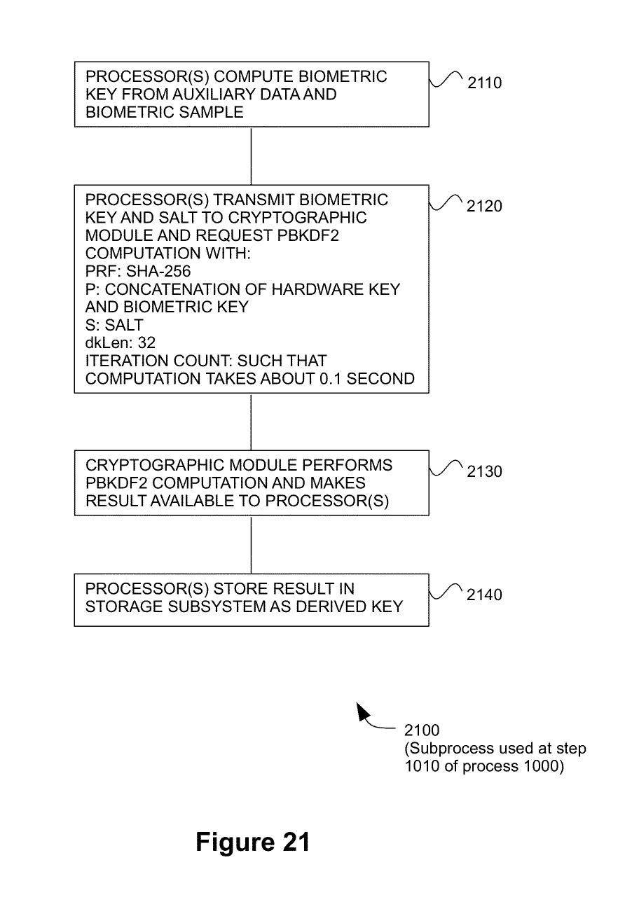

FIG. 21 is a flow diagram illustrating a subprocess 2100 that takes place at step 1010 of process 1000 for computing the derived key 755, according to some embodiments where the computing device 110 is equipped with the cryptographic module as in the embodiments of FIG. 20, the non-stored secrets 175 consist of a biometric sample 1410 as in FIG. 14 and the derivation parameters 710 consist of a salt 1510 and auxiliary data 1520 as in FIG. 15.

At 2110 the processor(s) 130 compute a biometric key from the auxiliary data 1520 and the biometric sample 1410. Then the subprocess continues at 2120.

At 2120 the processor(s) transmit the biometric key computed at step 2110 and the salt 1510 to the module, and instruct the module to perform a PBKDF2 computation with:
SHA-256 as the PRF;
the concatenation of the hardware key 430 and the biometric key as the value of the argument “P”, the hardware key being present in the module, and the module having circuitry to perform the concatenation and use it as the value of “P”;
the salt 1510 as the value of the argument “S”;
32 as the value of the argument “dkLen”; and
an iteration count specified by the processor(s) so that the computation takes about 0.1 second. Then the subprocess continues at 2130.

At 2130 the module performs the requested computation and makes the result available to the processor(s). Then the subprocess continues at 2140.

At 2140 the processor(s) store the result of the computation in the storage subsystem 105 as the value of the derived key 755. Then the subprocess terminates.

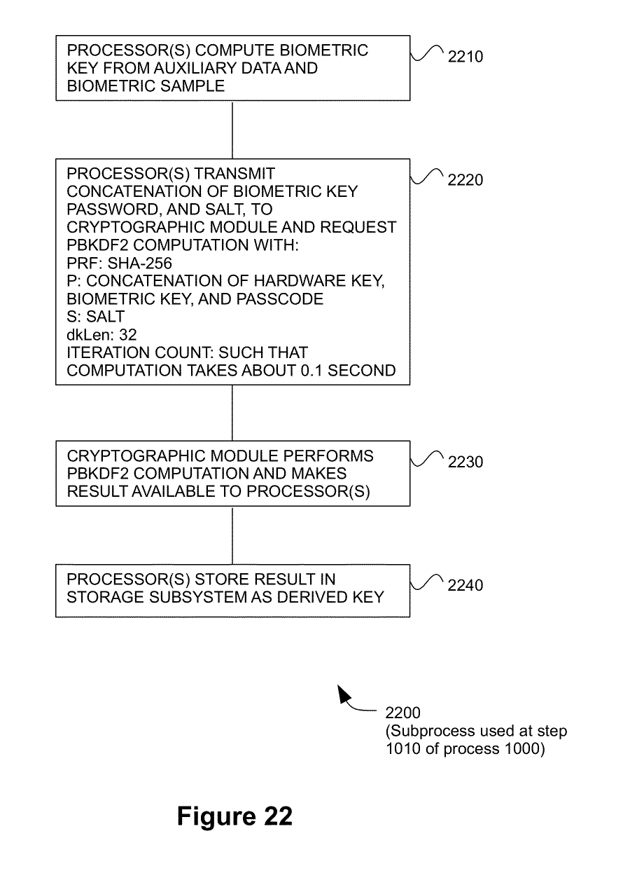

FIG. 22 is a flow diagram illustrating a subprocess 2200 that takes place at step 1010 of process 1000, similar to the subprocess 2100, for computing the derived key according to embodiments where the non-stored secrets 175 consist of both a passcode 1710 and a biometric sample 1720 as in FIG. 17, the derivation parameters consisting of a salt and auxiliary data as in FIGS. 15 and 18. A biometric key is computed from the auxiliary data and the biometric sample as in subprocess 2100. The subprocess 2200 differs from the subprocess 2100 in that the processor(s) 130 transmit to the module 410 the concatenation of the biometric key and the passcode instead of the biometric key, and instruct the module to use the concatenation of the hardware key, the biometric key, and the passcode as the value of the argument “P”.

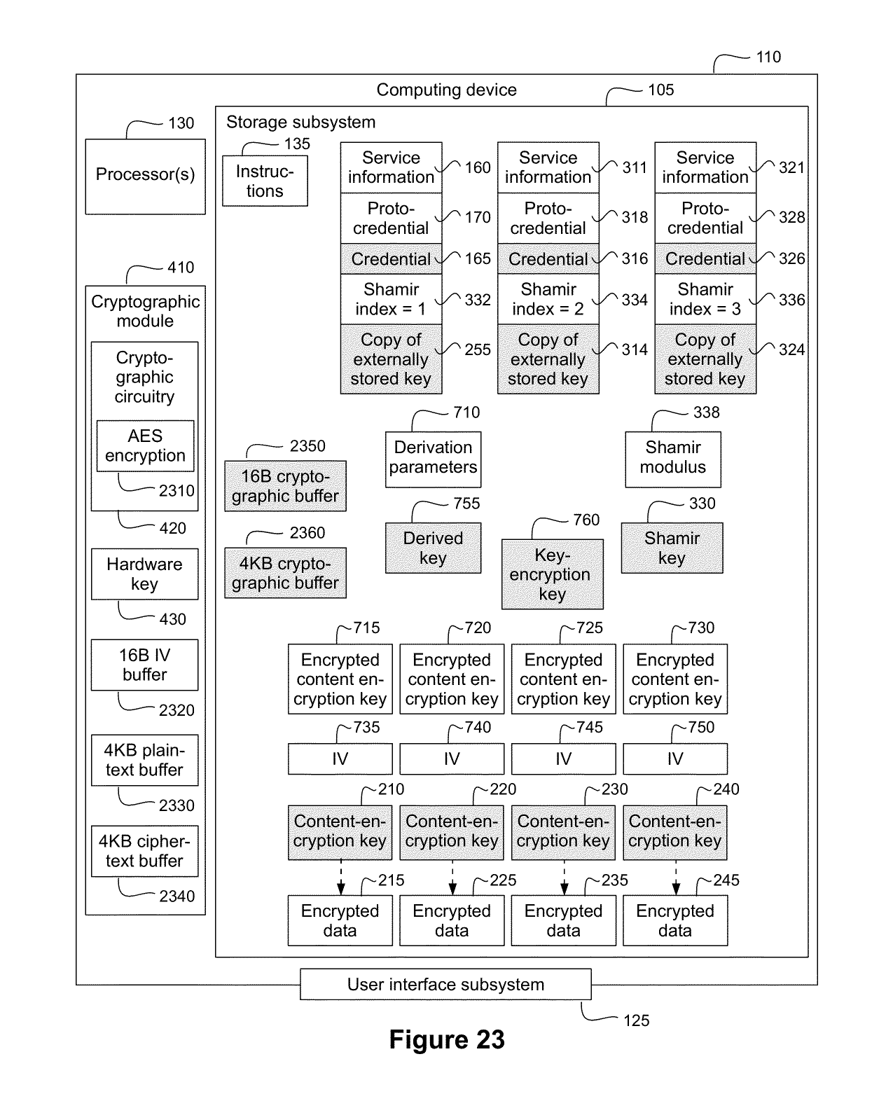

FIG. 23 is a block diagram illustrating the computing device 110 according to some embodiments where the device is equipped with the cryptographic module 410, and the cryptographic circuitry 420 in the module comprises circuitry 2310 implementing the AES encryption algorithm in CBC mode, using the hardware key 430 as the encryption key. The length of the hardware key is 128 bits, 192 bits or 256 bits in various embodiments. In some embodiments the cryptographic circuitry also includes circuitry implementing the AES decryption algorithm.

The module comprises a 16 byte (16 B) initialization vector (IV) buffer 2320 for storing the 128 bit initialization vector required by the CBC mode, a 4 kilobyte (4 KB) plaintext buffer 2330 for storing up to 4 KB of plaintext, and another 4 KB buffer 2340 for storing up to 4 KB of ciphertext. In alternative embodiments the size of the plaintext and ciphertext buffers may be other than 4 KB, but not less than the size of the derived key 755. Also, in alternative embodiments, the module may contain a single 4 KB module that contains the plaintext before the encryption and is overwritten with the ciphertext as the encryption is performed.

To facilitate the interactions with the module, the processor(s) 130 make use of a 16 B buffer 2350 and a 4 B buffer 2360 allocated in the storage subsystem 105, which will be called hereinafter the “16 B cryptographic buffer” and the “4 KB cryptographic buffer” respectively.

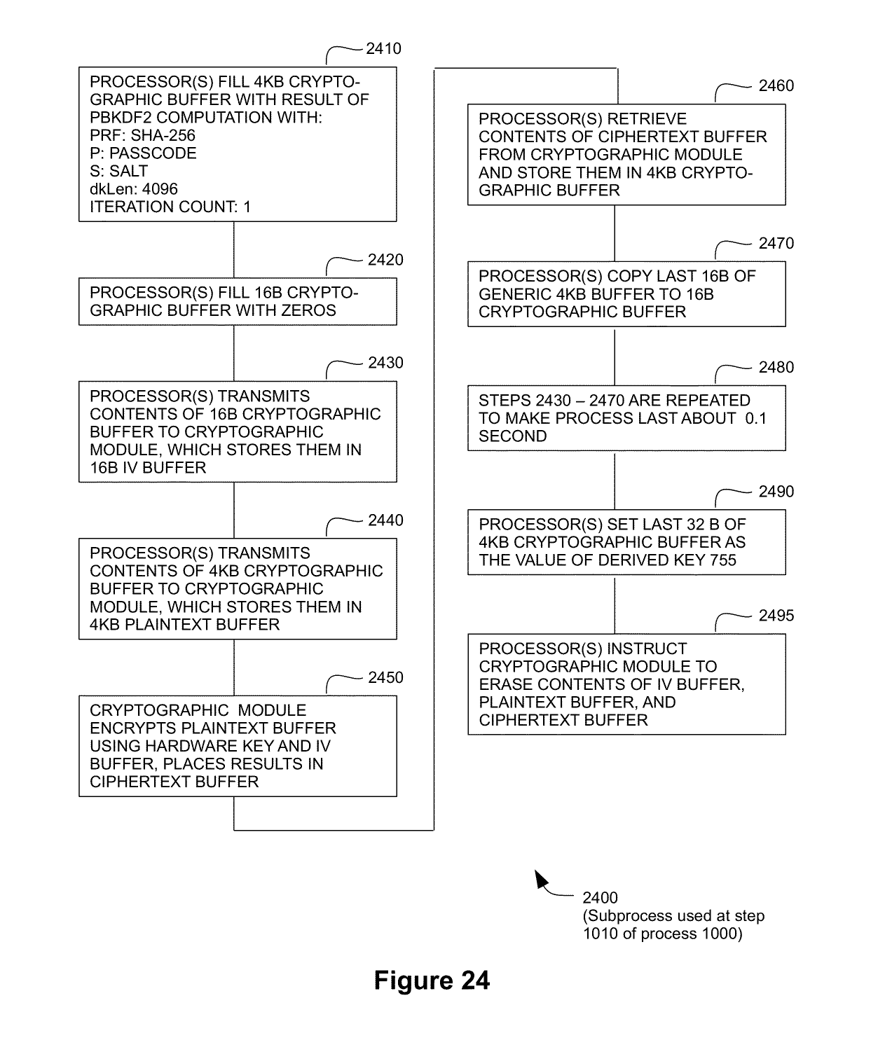

FIG. 24 is a flow diagram illustrating a subprocess 2400 that takes place at step 1010 of process 1000 for computing the derived key 755, according to some embodiments where the computing device 110 is equipped with the cryptographic module 410, the circuitry 420 in the module implements AES encryption as illustrated in FIG. 23, the non-stored secrets 175 consist of a passcode 1110 as illustrated in FIG. 11, and the derivation parameters 710 consist of a salt 1210 as illustrated in FIG. 12.

At 2410 the processor(s) 130 compute a 4 KB expanded key using the key derivation function PBKDF2 with SHA-256 as the PRF, the passcode 1110 as the value of “P”, the salt 1210 as the value of “S”, 4096 as the value of “dkLen”, and 1 as the iteration count. (In alternative embodiments a different key derivation function, such as the function HKDF specified in RFC 5869 of the IETF, may be used instead of PBKDF2.) The processor(s) store the 4 KB key in the 4 KB cryptographic buffer 2360 located in the storage subsystem. Then the subprocess continues at 2420.

At 2420 the processor(s) fill with zeros the 16 B cryptographic buffer 2350 located in the storage subsystem. Then the subprocess continues at 2430.

At 2430 the processor(s) transmit the contents of the 16 B cryptographic buffer 2350 in the storage subsystem to the cryptographic module, which stores them in the 16 B IV buffer 2320. Then the subprocess continues at 2440.

At 2440 the processor(s) transmit the contents of the 4 KB cryptographic buffer 2360 in the storage subsystem to the cryptographic module, which stores them in the 4 KB plaintext buffer 2330. Then the subprocess continues at 2450.

At 2450 the module encrypts the contents of the plaintext buffer using the hardware key 430 as encryption key and the contents of the IV buffer as initialization vector, placing the resulting ciphertext in the 4 KB ciphertext buffer 2340. Then the subprocess continues at 2460.

At 2460 the processor(s) retrieve the contents of the ciphertext buffer from the cryptographic module and store them in the 4 KB cryptographic buffer. Then the subprocess continues at 2470.

At 2470 the processor(s) copy the last 16 B of the 4 KB cryptographic buffer to the 16 B cryptographic buffer. Then the subprocess continues at 2480.

At 2480 steps 2430-2470 are repeated a number of times configured so that the time taken by subprocess 2400 is approximately 0.1 second. Then the subprocess continues at 2490.

At 2490 the processor(s) set the last 32 bytes (256 bits) of the 4 KB cryptographic buffer as the value of the derived key 755. Then the subprocess continues at 2495.

At 2495 the processor(s) instruct the module to erase the contents of the IV buffer, plaintext buffer, and ciphertext buffer. Then the subprocess terminates.

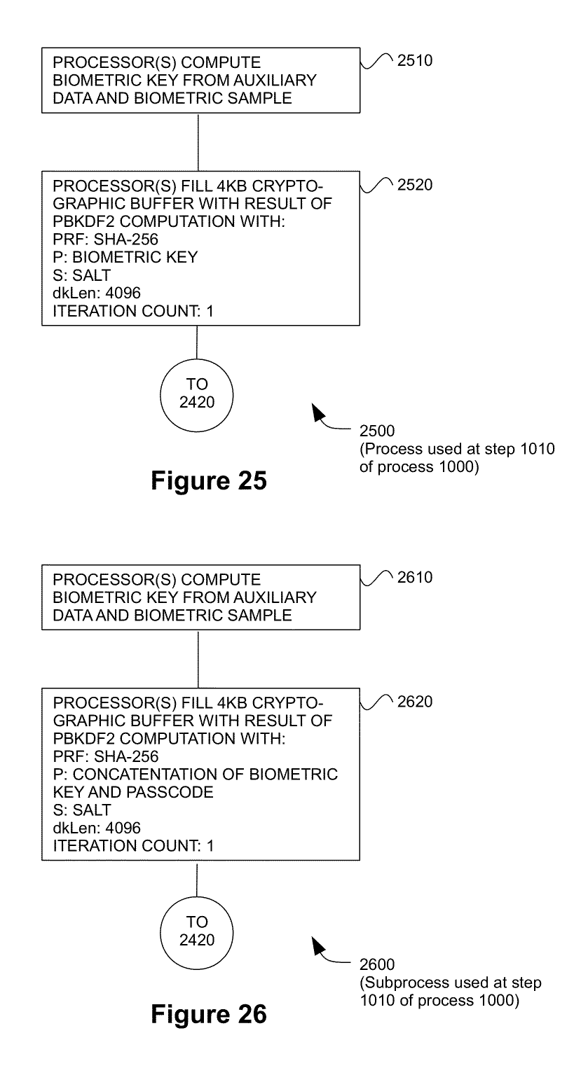

FIG. 25 is a partial flow diagram illustrating a subprocess 2500 that takes place at step 1010 of process 1000 for computing the derived key 755, according to some embodiments where the computing device 110 is equipped with the cryptographic module 410, the circuitry 420 in the module implements AES encryption as illustrated in FIG. 23, the non-stored secrets 175 consist of a biometric sample 1410 as illustrated in FIG. 14, and the derivation parameters 710 consist of a salt 1510 and auxiliary data 1520 as illustrated in FIG. 15.

Subprocess 2500 is the same as subprocess 2400 except that the first step 2410 of subprocess 2400 is replaced by two steps 2510, 2520 in subprocess 2500.

At 2510 the processor(s) 130 compute a biometric key from the auxiliary data 1520 and the biometric sample 1410. Then the subprocess continues at 2520.

At 2520 the processor(s) 130 compute a 4 KB expanded key using the key derivation function PBKDF2 with SHA-256 as the PRF, the biometric key computed at step 2510 as the value of “P”, the salt 1510 as the value of “S”, 4096 as the value of “dkLen”, and 1 as the iteration count. The processor(s) store the 4 KB key in the 4 KB cryptograhpic buffer 2360 located in the storage subsystem. Then the subprocess continues as subprocess 2400, from step 2420 onward.

FIG. 26 is a partial flow diagram illustrating a subprocess 2600 that takes place at step 1010 of process 1000 for computing the derived key 755, according to some embodiments where the computing device 110 is equipped with the cryptographic module 410, the circuitry 420 in the module implements AES encryption as illustrated in FIG. 23, the non-stored secrets 175 consist of a biometric sample 1710 and a passcode 1720 as illustrated in FIG. 17, and the derivation parameters 710 consist of a salt 1810 and auxiliary data 1820 as illustrated in FIG. 18.

Subprocess 2600 is the same as subprocess 2400 except that the first step 2410 of subprocess 2400 is replaced by two steps 2610, 2620 in subprocess 2600.

At 2610 the processor(s) 130 compute a biometric key from the auxiliary data 1820 and the biometric sample 1710. Then the subprocess continues at 2620.

At 2620 the processor(s) 130 compute a 4 KB expanded key using the key derivation function PBKDF2 with SHA-256 as the PRF, the concatenation of the biometric key computed at step 2510 and the passcode 1720 as the value of “P”, the salt 1510 as the value of “S”, 4096 as the value of “dkLen”, and 1 as the iteration count. The processor(s) store the 4 KB key in the 4 KB cryptographic buffer 2360 located in the storage subsystem. Then the subprocess continues as subprocess 2400, from step 2420 onward.

FIG. 27 is a flow diagram illustrating a subprocess 2700, used at steps 1015, 1020 and 1025 of process 1000, for retrieving an externally stored key, such as the key 250, 312 or 322 when the subprocess is used at step 1015, 1020 or 1025 respectively, from a key storage service, such as the service 150, 310 or 320 when the subprocess is used at step 1015, 1020 or 1025 respectively, according to some embodiments.

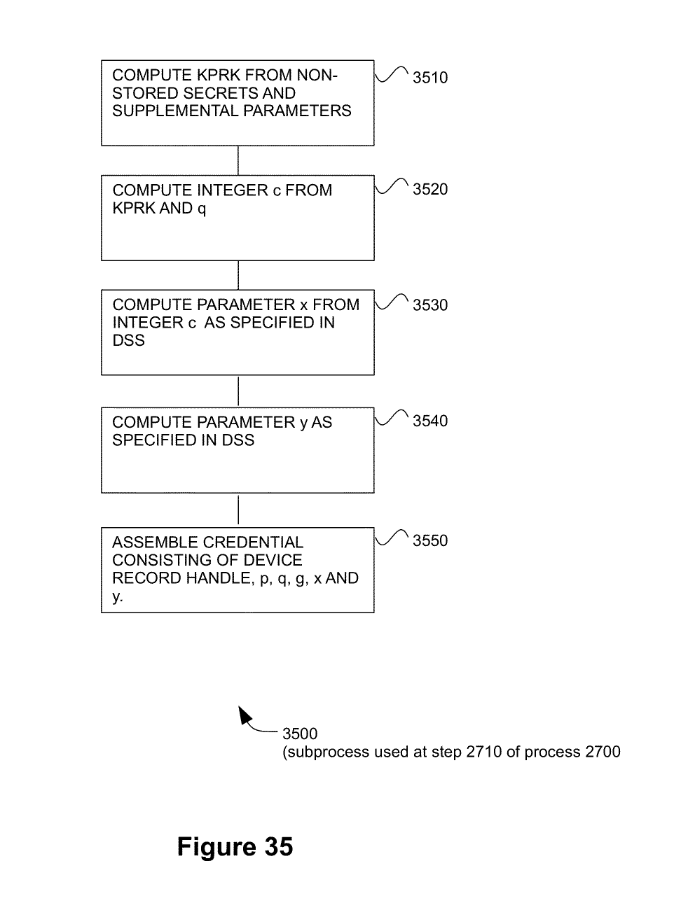

At 2710 the computing device 110 regenerates the credential (165, 316 or 326 when the subprocess is used at step 1015, 1020 or 1025 respectively) that will be used for authentication from the corresponding protocredential (170, 318 or 328 when the subprocess is used at step 1015, 1020 or 1025 respectively) and the non-stored secrets 175. A subprocess for regenerating a credential from a protocredential and the non-stored secrets is described below and illustrated in FIG. 35. After step 2710, subprocess 2700 continues at 2720.

At 2720 the device establishes a secure connection to the key storage service. In some embodiments this is accomplished by establishing an underlying connection such as a carrier network connection, a TCP connection or a peer-to-peer connection, and a TLS connection over the underlying connection. The device uses key storage service information (160, 311 or 321 when the subprocess is used at step 1015, 1020 or 1025 respectively), such as a network address to establish the underlying connection. TLS connection establishment includes a TLS handshake where the key storage service authenticates with a TLS server certificate. Some services authenticate with a self-signed certificate, which the device verifies by comparing a hash of the self-signed certificate to a hash included in the service information. Some services authenticate with a certificate backed by a certificate chain ending in a self-signed certificate of a root certification authority (CA); the device verifies that the self-signed certificate is present in a root certificate store included in the storage subsystem 105 and that the other certificates are correctly signed and have not been revoked. Then the subprocess continues at 2730.

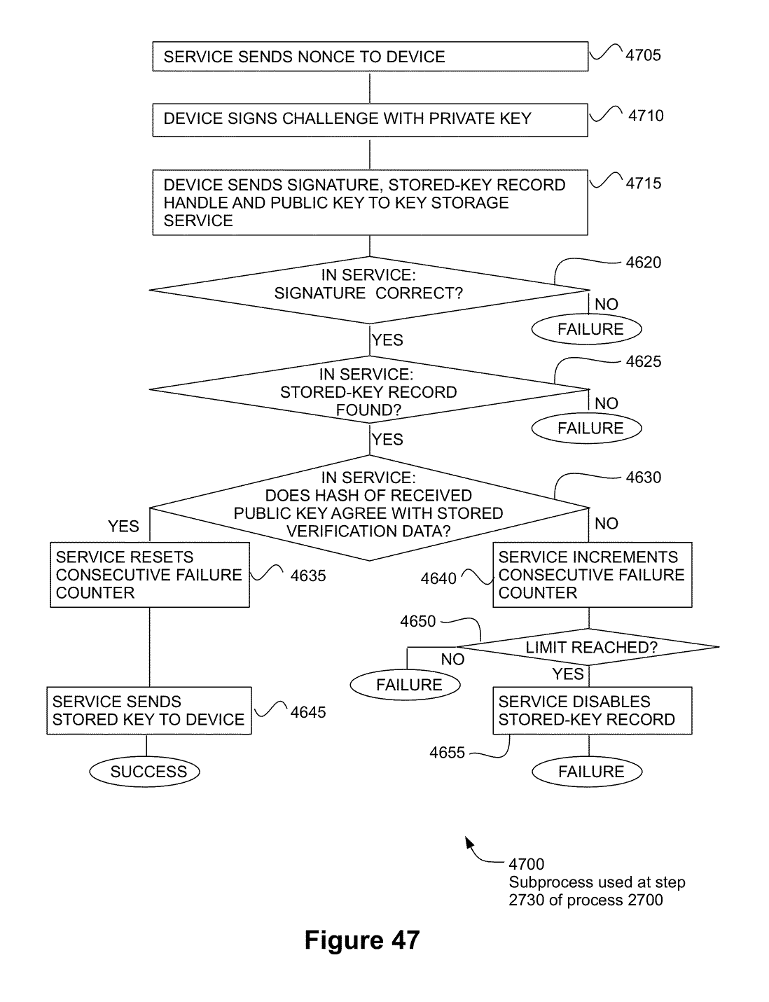

At 2730 the device makes an authenticated request over the secure connection for the externally stored key to the key storage service. A subprocess for performing step 2730 is described below and illustrated in FIG. 47. After step 2730, subprocess 2700 continues at 2740.

At 2740 the key storage service sends a copy of the externally stored key (255, 314 or 324 when the subprocess is used at step 1015, 1020 or 1025 respectively) to the device, which stores it in the storage subsystem. Then the subprocess terminates.

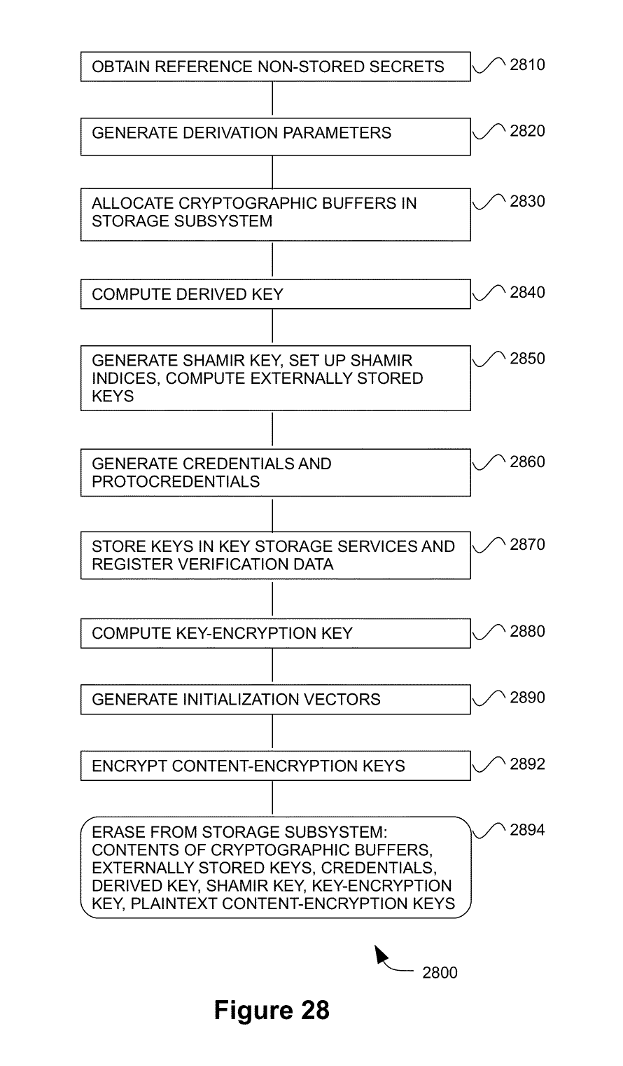

FIG. 28 is a flow diagram illustrating a process 2800 for setting up system 300 or 400 for protecting the confidential data 215, 225, 235, 245, according to some embodiments where the storage subsystem 105 as illustrated in FIG. 9. Some steps and substeps are omitted in some embodiments as indicated below.

The process is executed when the user locks the device for the first time. (A similar process that omits step 2894 is used in alternative embodiments where the setup is not immediately followed by the device becoming locked.) Before the device is locked for the first time, the confidential data is stored encrypted, but the content-encryption keys 210, 220, 230, 240 are stored in the device in the clear. The process protects the data by creating encrypted forms 715, 720, 725, 730 of the content-encryption keys, erasing their plaintext forms 210, 220, 230, 240, and storing data in the storage subsystem 105 that will make it possible to decrypt the content-encryption keys when the user unlocks the device.

Before process 2800 is executed, the user 120 has made arrangement with the key storage services 150, 310, 320 and the device has obtained authorization codes for storing keys in those services. The service information 160, 311, 321 is present in the storage subsystem 105, but the protocredentials, credentials, externally stored keys have not been generated yet. There are no Shamir indices, Shamir modulus, Shamir key, derivation parameters, derived key or key-encryption key in the device.

At 2810 the device obtains reference non-stored secrets 175 from the user 120, such as a passcode, a reference biometric sample, or both a passcode and a reference biometric sample. Then the process continues at 2820.

At 2820 the device generates the derivation parameters 710. In some embodiments where the derivation parameters include a salt, such as the salt 1210 or 1510 of FIG. 12 or 15, the salt is a 32-byte string generated at random. In some embodiments where the derivation parameters include auxiliary data for computing a biometric key, such as auxiliary data 1520 or 1820 of FIG. 15 or 18, the auxiliary data is generated from a biometric sample included in the non-stored secrets 175, such as the biometric sample 1410 or 1710 of FIG. 14 or 17, as described in the biometric authentication literature referenced above. Then, in embodiments that implement step 1010 of process 1000 using subprocesses 2400, 2500 or 2600, the process continues at 2830. In other embodiments step 2830 is omitted and the process continues at 2840.

At 2830 the device allocates the 16 B cryptographic buffer 2350 and the 4 KB cryptographic buffer 2360. Then the process continues at 2840.

At 2840 the device computes the derived key 755 using a subprocess also used at step 1010 of process 1000, such as subprocess 1300, 1600, 1900, 2000, 2100, 2200, 2400, 2500 or 2600. Different subprocesses are used by different embodiments, according to kind of non-stored secrets used in each embodiment, according to whether the device is equipped with a cryptographic module 410, and according to the functionality implemented by the cryptographic circuitry 420 in the module. Then the process continues at 2850.

At 2850 the device computes the externally stored keys and sets up the data structures that will be used to compute the Shamir key according to the Shamir Secret Sharing technique referenced above. First, the device generates the Shamir key 330 as a random 32-byte string, interpreted as a 256-bit number. (Other Shamir key sizes may be used in alternative embodiments, such as 128 bits in embodiments where the processor(s) 130 are slow. In other alternative embodiments, multiprecision arithmetic operations are avoided by breaking the secret D of Shamir's paper, i.e. the Shamir key, into short blocks as described in the paper.) Then a 256-bit prime number “p” greater than the Shamir key is chosen. Then a random polynomial over the field of integers module p is generated, in which the coefficient of the term of degree zero is D. In embodiments where the Shamir Secret Sharing technique is used with k=2, i.e. where two shares are sufficient to reconstruct D, the polynomial is of degree 1 and thus has one term of positive degree. Shamir's paper calls for choosing the coefficient of that term at random with a uniform distribution over the interval [0,p); in some embodiments, a roughly random distribution is achieved by taking the remainder of the division by p of a random 320-bit nonnegative integer. Then n shares are computed modulo p as the values of the polynomial when the variable of the polynomial takes as values the indices 1 . . . n of the shares. In embodiments where there are three shares, the device stores in the storage subsystem 105 the values 1, 2, 3 of three Shamir indices 332, 334, 336, and the Shamir modulus 338, which is a 32-byte string representing the prime number p. The keys 250, 312, 322 to be externally stored in the key storage services are 32-byte representations of the shares. Then the process continues at 2860.

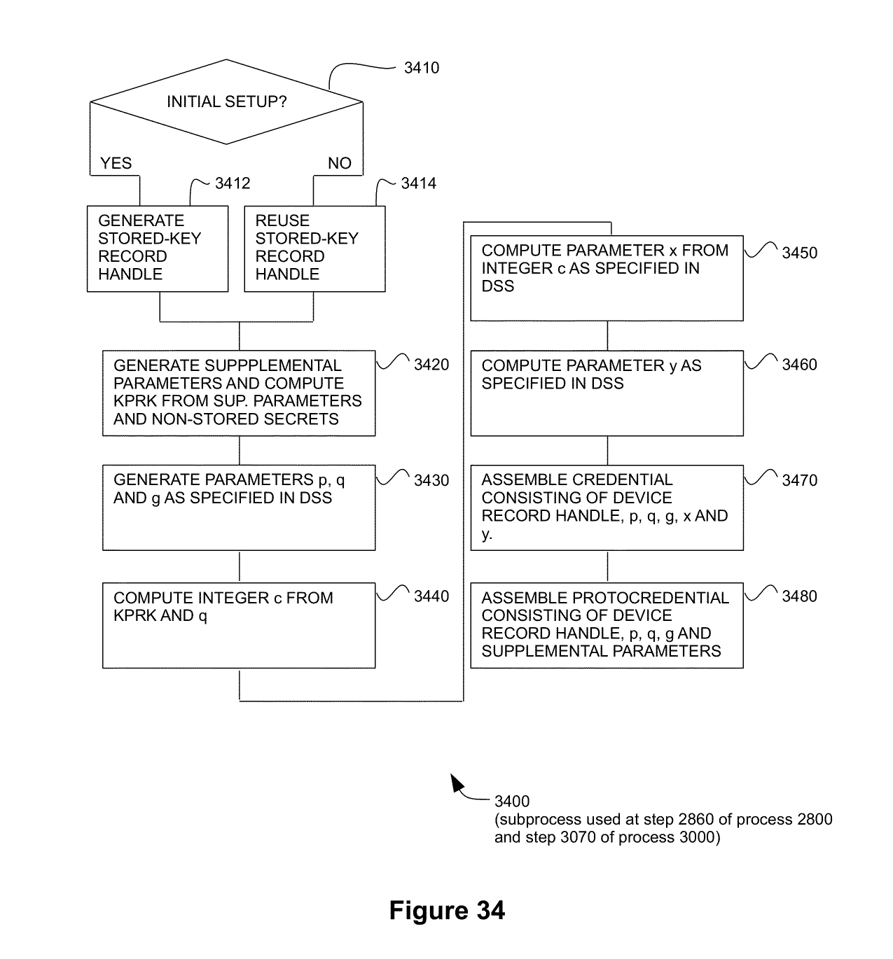

At 2860 the device generates the credentials 165, 316, 326 that will be used to authenticate requests made to each of the key storage services and the protocredentials 170, 318, 328 that will be used to regenerate the credentials. A subprocess for generating a credential and corresponding protocredential from the non-stored secrets 175 is described below and illustrated in FIG. 34. Then the process continues at 2870.

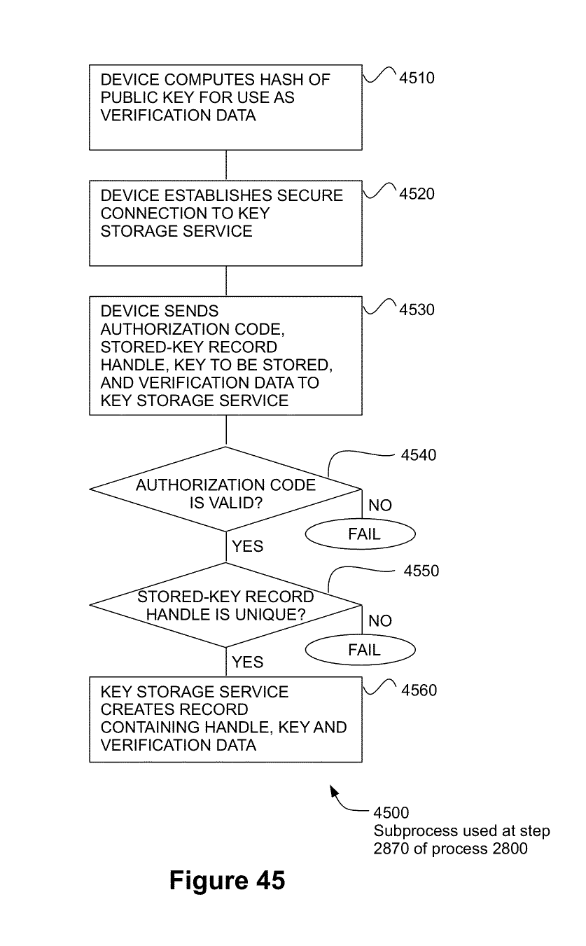

At 2870 the device externally stores the keys 250, 312, 322 at the key storage services and registers verification data that the services will use to verify the credentials 165, 316, 326. A subprocess for externally storing a key and registering verification data with a key storage service is described below and illustrated in FIG. 45. Then the process continues at 2880.

At 2880 the device computes the key-encryption key 760 as at step 1035 of process 1000. Then the process continues at 2890.

At 2890 the device generates 16-byte random strings 735, 740, 745, 750 to be used as initialization vectors and stores them in the storage subsystem. Then the process continues at 2892.

At 2892 the device encrypts the content-encryption keys 210, 220, 230, 240 with the encryption algorithm specified in the AES operated in CBC mode using the key-encryption key 760 and the initialization vectors 735, 740, 745, 750 respectively, and stores the resulting encrypted content-encryption keys 715, 720, 725, 730 in the storage subsystem. Then the process continues at 2894.

At 2894 the device erases from the storage subsystem the following data:
the contents of the 16 B and 4 KB cryptographic buffers, in embodiments that implement step 1010 of process 1000 using subprocesses 2400, 2500 or 2600;
the keys 250, 312, 322 that have been stored in the key storage services;
the credentials;
the derived key;
the Shamir key;
the key-encryption key; and
the plaintext forms 210, 220, 230, 240 of the content-encryption keys. Then the process terminates.

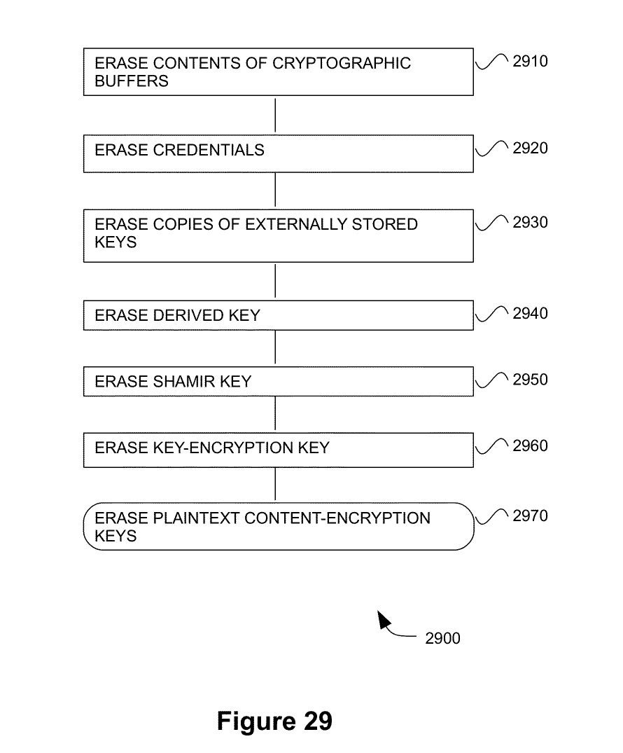

FIG. 29 is a flow diagram illustrating a process 2900 for protecting the confidential data 215, 225, 235, 245 in system 300 or 400 when the user locks the computing device 110 one more time, after having previously locked it and unlocked it at least once, according to some embodiments where the storage subsystem 105 as illustrated in FIG. 9. The process protects the data by erasing the plaintext forms 210, 220, 230, 240 of the content-encryption keys and other data that could help an adversary who captures the device in obtaining the plaintext forms.

The process starts at 2910 in embodiments that implement step 1010 of process 1000 using subprocesses 2400, 2500 or 2600. In other embodiments the process starts at 2920.

At 2910 the device erases the contents of the 16 B cryptographic buffer 2350 and the 4 KB cryptographic buffer 2360. Then the process continues at 2920.

At 2920 the device erases the credentials 165, 316, 326 from the storage subsystem 105. Then the process continues at 2930.

At 2930 the device erases the copies 255, 314, 324 of the externally stored keys from the storage subsystem. Then the process continues at 2940.

At 2940 the device erases the derived key 755 from the storage subsystem. Then the process continues at 2950.

At 2950 the device erases the Shamir key 330 from the storage subsystem. Then the process continues at 2960.

At 2960 the device erases the key-encryption key 760 from the storage subsystem. Then the process continues at 2970.

At 2970 the device erases the plaintext forms 210, 220, 230, 240 of the content-encryption keys from the storage subsystem. Then the process terminates.

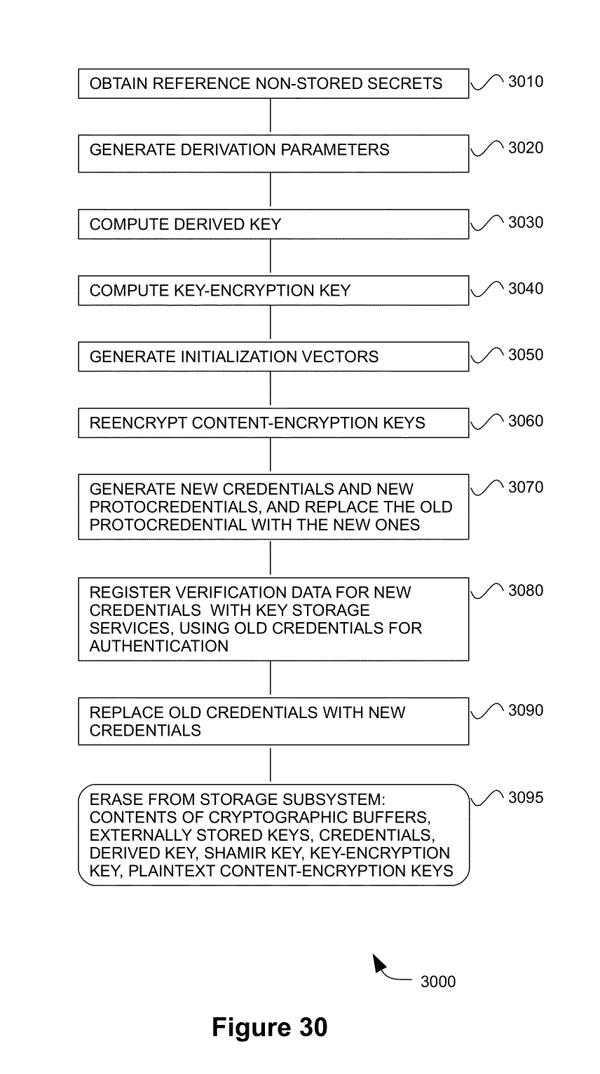

FIG. 30 is a flow diagram illustrating a process 3000 for updating system 300 or 400 when the user submits new reference non-stored secrets 175, according to some embodiments where the storage subsystem 105 as illustrated in FIG. 9. Submission of new reference non-stored secrets requires generation of new credentials for obtaining the externally stored keys, but does not require changing the externally stored keys themselves. Submission of new reference non-stored secrets also requires updating the key-encryption key and reencrypting the content-encryption keys. The device becomes locked after the system has been updated by process 3000. (A similar process that omits step 3095 is used in alternative embodiments where the update is not immediately followed by the device becoming locked.)

At 3010 the device obtains the new reference non-stored secrets. Then the process continues at 3020.

At 3020 the device generates the derivation parameters 710. In some embodiments where the derivation parameters include a salt, such as the salt 1210 or 1510 of FIG. 12 or 15, the salt is a 32-byte string generated at random. In some embodiments where the derivation parameters include auxiliary data for computing a biometric key, such as auxiliary data 1520 or 1820 of FIG. 15 or 18, the auxiliary data is generated from the new reference biometric sample included in the new reference non-stored secrets 175, as described in the biometric authentication literature referenced above. Then the process continues at 3030.

At 3030 the device computes the derived key 755 using a subprocess also used at step 1010 of process 1000 and step 2840 of process 2800, such as subprocess 1300, 1600, 1900, 2000, 2100, 2200, 2400, 2500 or 2600. Then the process continues at 3040.

At 3040 the device computes the key-encryption key 760 as at step 1035 of process 1000 and step 2880 of process 2800. Then the process continues at 3050.

At 3050 the device generates new initialization vectors as at step 2890 or process 2800. Then the process continues at 3060.

At 3060 the device reencrypts the content-encryption keys 210, 220, 230, 240 with the encryption algorithm specified in the AES operated in CBC mode using the new key-encryption key and the new initialization vectors, and stores the reencrypted content-encryption keys 715, 720, 725, 730 in the storage subsystem. Then the process continues at 3070.

At 3070 the device generates new credentials that will be used in the future to authenticate requests made to each of the key storage services, and new protocredentials that will be used to regenerate the new credentials. The new protocredentials replace the current protocredentials at their storage locations 170, 318, 328; however, the new credentials do not immediately replace the current credentials at their long term storage locations 165, 316, 326, because the current credentials are needed for authentication at 3080; the new credentials are kept in temporary storage location until they replace the current credentials at the long term locations at 3090. A subprocess for generating a credential and corresponding protocredential from the non-stored secrets 175 is described below and illustrated in FIG. 34. After step 3070, the process continues at 3080.

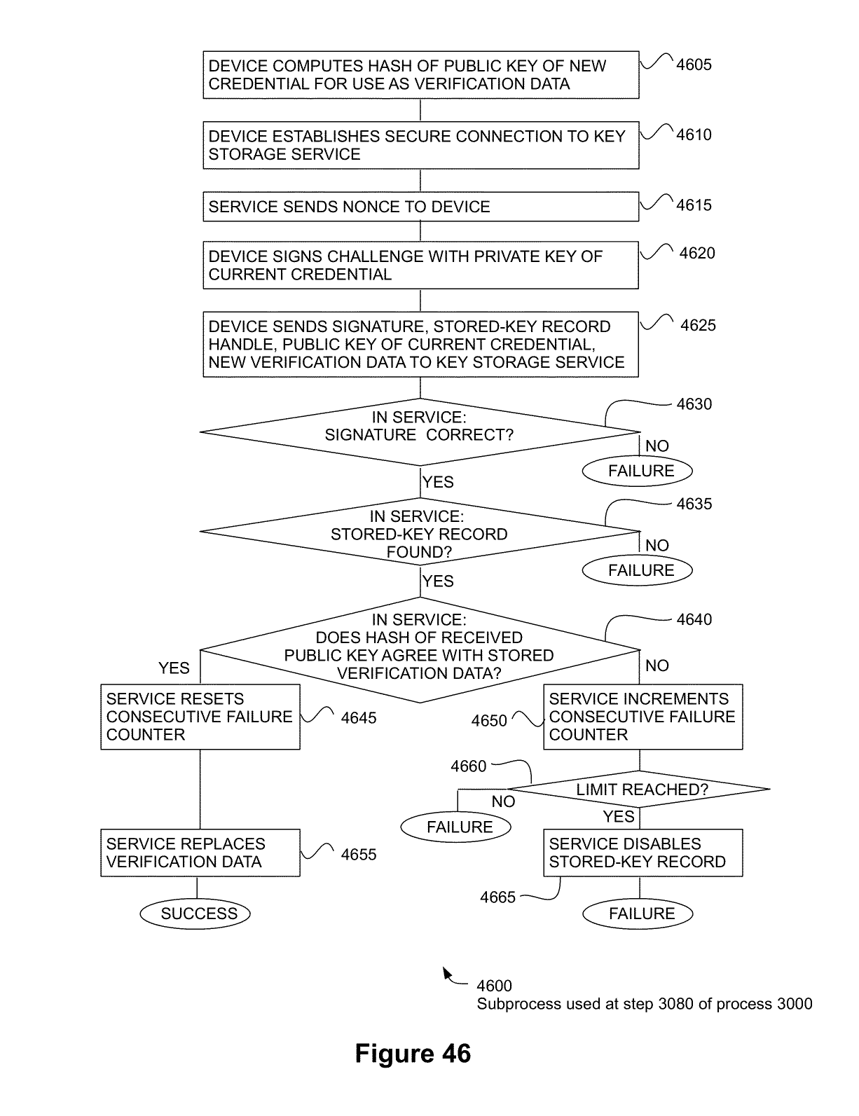

At 3080 the device registers verification data with the key storage services 150, 310, 320 that each service will use to verify the corresponding new credential, using the corresponding current credential for authentication. A subprocess for registering verification data for a new credential using a current credential for authentication is described below and illustrated in FIG. 46. After step 3080, the process continues at 3090.

At 3090 the device replaces the current credentials with the new credentials at the storage locations 165, 316, 326. Then the process continues at 3095.

At 3095 the device erases from the storage subsystem the following data:
the contents of the 16 B and 4 KB cryptographic buffers, in embodiments that implement step 1010 of process 1000 using subprocesses 2400, 2500 or 2600;
the externally stored keys 250, 312, 322;
the new credentials;
the new derived key;
the Shamir key;
the new key-encryption key; and
the plaintext forms 210, 220, 230, 240 of the content-encryption keys. Then the process terminates.

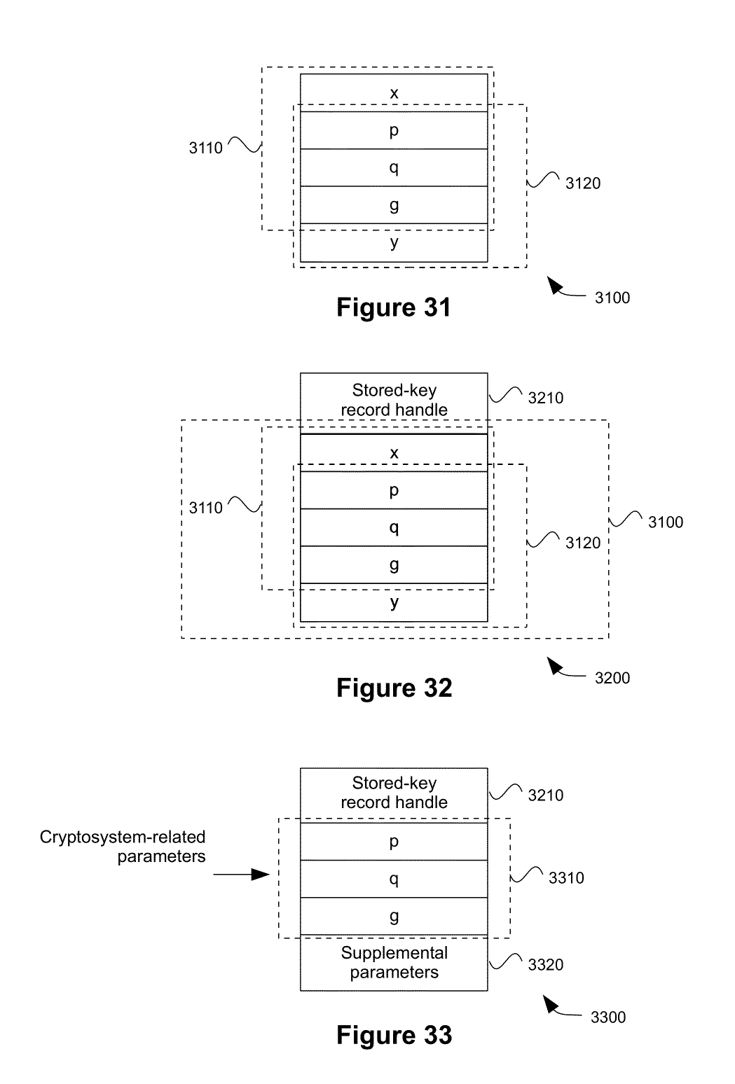

FIG. 31 is a block diagram illustrating a key pair 3100 pertaining to the Digital

Signature Algorithm (DSA) cryptosystem, using the notations of Section 4.1 of the Digital Signature Standard (DSS), publication FIPS PUB 186-4 of the National Institute of Standards and Technology (NIST). The key pair comprises parameters p, q, g, x and y. As in the DSS, the variables L and N will be used hereinafter to refer to the bitlengths of p and q respectively. A signature is computed using x, p, q and g (plus a per-message secret parameter k) as specified in Section 4.6 of the DSS. A signature is verified using the parameters y, p, q and g as specified in Section 4.7 of the DSS.

The DSS refers to parameter x as the private key, to parameter y as the public key, and to parameters p, q and g as domain parameters (because they could be shared by multiple key pairs within a domain). However, since x, p, q and g are needed to compute a signature, the private key 3110 is herein defined as comprising x, p, q and g; and since y, p, q and g are needed to verify a signature, the public key 3120 is herein defined as comprising y, p, q and g.

FIG. 32 is a block diagram illustrating a credential 3200 that plays the role of one of the credentials 165, 316, 326 in some embodiments. The credential 3200 comprises a stored-key record handle 3210 and the key pair 3100, with the parameters p, q, g, x and y encoded as strings of respective bitlengths L, N, L, N and L.

FIG. 33 illustrates a protocredential 3300 that plays the role of one of the protocredentials 170, 318, 328 in some embodiments, and is used in conjunction with the non-stored secrets 175 to regenerate the credential 3200 of FIG. 32. The protocredential 3300 comprises the stored-key record handle 3210, a set of cryptosystem-related parameters 3310 consisting of p, q and g encoded as strings of bitlengths L, N and L, and a set of supplemental parameters 3320 related to the non-stored secrets. The supplemental parameters are considered secrets.

FIG. 34 is a flow diagram illustrating a subprocess 3400 for generating a credential such as the credential 3200 of FIG. 32 and a protocredential such as the protocredential 3300 of FIG. 33 from the non-stored secrets 175. The subprocess 3400 is used during initial system setup, at step 2860 of process 2800, and during a system update, at step 3070 of process 3000. When used during a system update the credential and protocredential are being generated as replacements of an existing credential and protocredential, which comprise an existing stored-key record handle 3210.

At 3410, the subprocess tests whether it is being used at initial system setup or during system update. If used at initial setup, the subprocess continues at 3412. Otherwise it continues at 3414.

At 3412 the computing device 110 generates the stored key record handle 3210 as a random high-entropy string, so that it is different from any other stored-key record handles with high probability. Then the subprocess continues at 3420.

At 3414 the device reuses the existing stored-key record handle as the stored-key record handle 3210 of the credential 3200 and the protocredential 3300 being generated.

At 3420 the device generates the supplemental parameters 3320 and computes a Key-Pair Regeneration Key (KPRK) from the supplemental parameters and the non-stored secrets. The KPRK is of bitlength N+64, N being the bitlength of q. Subprocesses for performing step 3420 are described below and illustrated in FIGS. 37, 40 and 43. After step 3420, subprocess 3400 continues at 3430.

At 3430 the device generates the parameters p, q and g as described in Section 4.3.1 and appendices A.1 and A.2 of the DSS. Then the subprocess continues at 3440.

At 3440 the device computes an integer “c” as specified at step 5 of the process described in Appendix B.1.1 of the DSS, using the KPRK instead of the string called “returned bits” in the DSS. Then the subprocess continues at 3450.

At 3450 the device computes the parameter x as specified in step 6 of the process described in Appendix B.1.1 of the DSS, using the integer “c” computed at step 1840. Then the subprocess continues at 3460.

At 3460 the device computes the parameter y as specified in step 7 of the process described in Appendix B.1.1 of the DSS. Then the subprocess continues at 1870.

At 3470 the device assembles the credential 3200, consisting of the stored-key record handle 3210, and the parameters p, q, g, x and y, encoded as strings of bitlength L, N, L, N and L respectively. Then the subprocess continues at 3480.

At 3480 the device assembles the protocredential 3300, consisting of the stored-key record handle, the cryptosystem-related parameters p, q and g encoded as strings of bitlength L, N and L respectively, and the supplemental parameters. Then the subprocess terminates.

FIG. 35 is a flow diagram illustrating a subprocess 3500 for regenerating a credential such as the credential 3200 of FIG. 32 from a protocredential such as the protocredential 3300 of FIG. 33 and the set of non-stored secrets 175. The subprocess 3500 is used at step 2710 of process 2700.

At 3510 the device computes a KPRK of bitlength N+64, N being the bitlength of the parameter q in the protocredential, from the supplemental parameters 3320 and the non-stored secrets 175. Then the process continues at 3520.

At 3520 the device computes an integer “c” as specified at step 5 of the process described in Appendix B.1.1 of the DSS, using the KPRK instead of the string called “returned bits” in the DSS. Then the process continues at 3530.

At 3530 the device computes the parameter x from the integer c as specified in step 6 of the process described in Appendix B.1.1 of the DSS. Then the process continues at 3540.

At 3540 the device computes the parameter y as specified in step 7 of the process described in Appendix B.1.1 of the DSS. Then the process continues at 3550.

At 3550 the device assembles the credential 3200, consisting of the stored-key record handle found in the protocredential, the parameters p, q, g found in the protocredential, encoded as strings of bitlength L, N and L respectively, and the newly computed parameters x and y, encoded as strings of bitlength N and L respectively. Then the process terminates.

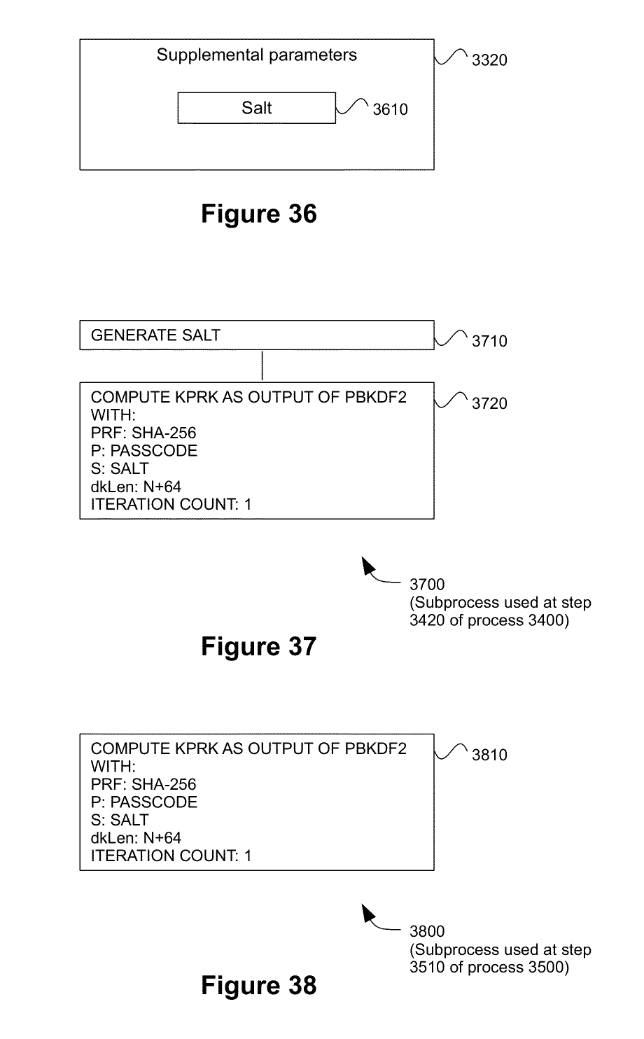

FIG. 36 is a block diagram illustrating the supplemental parameters 3320 according to some embodiments where the non-stored secrets 175 consist of a passcode 1110 as illustrated in FIG. 11. The supplemental parameters consist of a salt 3610. Different salts are used for different protocredentials.

FIG. 37 is a flow diagram illustrating a subprocess for generating the supplemental parameters 3320 of the protocredential 3300 and computing a KPRK from reference non-stored secrets 175, used at step 3420 of subprocess 3400, according to some embodiments where the non-stored secrets consist of a passcode 1110 as illustrated in FIG. 11, and the supplemental parameters 3320 consist of a salt 3610 as illustrated in FIG. 36.

At 3710 the device generates the salt 3610 as a random 32-byte string. Then the subprocess continues at 3720.

At 3720 the device computes the KPRK using PBKDF2 with:
SHA-256 as PRF;
the passcode 1110 as the value of “P”;
the salt 3610 as the value of “S”;
N+64 as the value of “dkLen”, N being the bitlength of the parameter q in the protocredential 3300; and
1 as the iteration count.
   (In alternative embodiments, HKDF may be used instead of PBKDF2.) Then the subprocess terminates.

FIG. 38 is a flow diagram illustrating a subprocess 3800 for computing a KPRK from the supplemental parameters 3320 of the protocredential 3300 and the non-stored secrets 175, used at step 3510 of subprocess 3500, according to some embodiments where the non-stored secrets are as in FIG. 11, and the supplemental parameters are as in FIG. 36. The process consists of a single step 3810. In other words, step 3810 is a more specific version of the step 3510 of FIG. 35.

At 3810 the device computes the KPRK using PBKDF2 with:
SHA-256 as PRF;
the passcode 1110 as the value of “P”;
the salt 3610 as the value of “S”;
N+64 as the value of “dkLen”, N being the bitlength of the parameter q in the protocredential 3300; and
1 as the iteration count.
   (In alternative embodiments, HKDF may be used instead of PBKDF2.) Then the subprocess terminates.

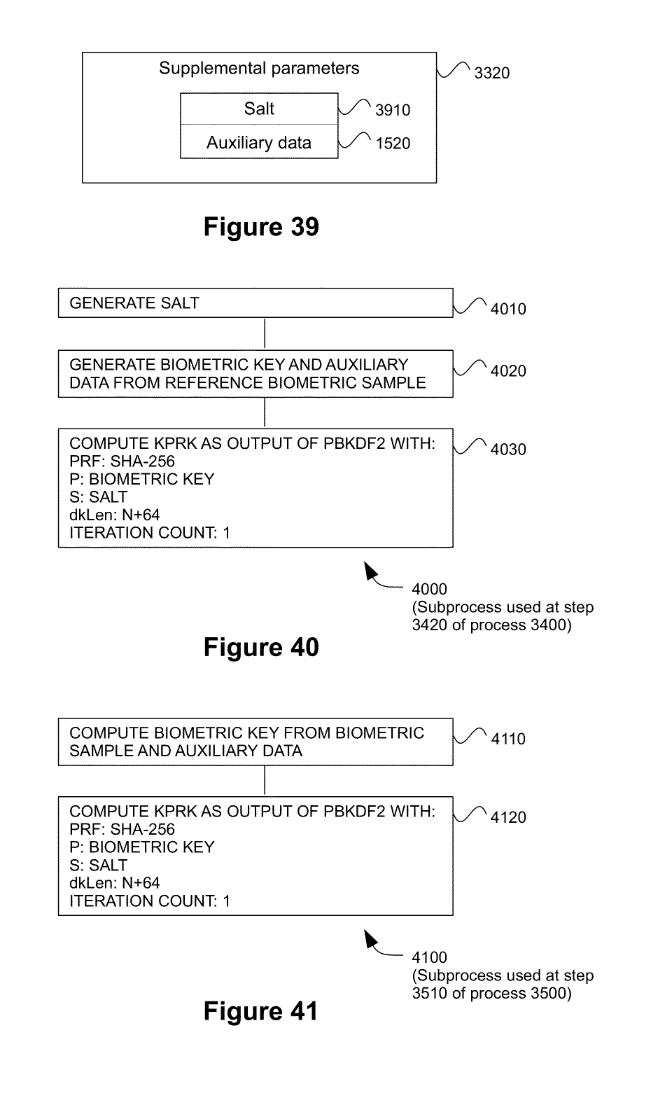

FIG. 39 is a block diagram illustrating the supplemental parameters 3320 according to some embodiments where the non-stored secrets 175 consist of a biometric sample 1410 as illustrated in FIG. 14. The supplemental parameters consist of a salt 3910 and the same auxiliary data 1520 that is part of the derivation parameters 710 illustrated in FIG. 15. Different salts are used for different protocredentials.

FIG. 40 is a flow diagram illustrating a subprocess for generating the supplemental parameters 3320 of the protocredential 3300 and computing a KPRK from reference non-stored secrets 175, used at step 3420 of subprocess 3400, according to some embodiments where the non-stored secrets consist of a biometric sample 1410 as illustrated in FIG. 14, and the supplemental parameters 3320 consist of the salt 3910 and the auxiliary data 1520 used to compute a biometric key, as illustrated in FIG. 39.

At 4010 the device generates the salt 3910 as a random 32-byte string. Then the subprocess continues at 4020.

At 4020 the device generates the biometric key and the auxiliary data from the biometric sample 1410 included in the reference non-stored secrets, as described in the biometric authentication literature referenced above. Then the subprocess continues at 4030.

At 4030 the device computes the KPRK using PBKDF2 with:
SHA-256 as PRF;
the biometric key generated at step 4020 as the value of “P”;
the salt 3910 as the value of “S”;
N+64 as the value of “dkLen”, N being the bitlength of the parameter q in the protocredential 3300; and
1 as the iteration count.
   (In alternative embodiments, HKDF may be used instead of PBKDF2.) Then the subprocess terminates.

FIG. 41 is a flow diagram illustrating a subprocess 4100 for computing a KPRK from the supplemental parameters 3320 of the protocredential 3300 and newly supplied non-stored secrets 175, used at step 3510 of subprocess 3500, according to some embodiments where the non-stored secrets are as in FIG. 14 and the supplemental parameters are as in FIG. 39.

At 4110 the device computes a biometric key from the biometric sample 1410 included in the newly supplied non-stored secrets and the auxiliary data 1520 included in the supplemental parameters 3320. This biometric key coincides with the biometric key generated at step 4020 of subprocess 4000 from the biometric sample included in the reference non-stored secrets. Then the subprocess continues at 4120.

At 4120 the device computes the KPRK using PBKDF2 with:
SHA-256 as PRF;
the biometric key computed at step 4110 as the value of “P”;
the salt 3910 as the value of “S”;
N+64 as the value of “dkLen”, N being the bitlength of the parameter q in the protocredential 3300; and
1 as the iteration count.
   (In alternative embodiments, HKDF may be used instead of PBKDF2.) Then the subprocess terminates.

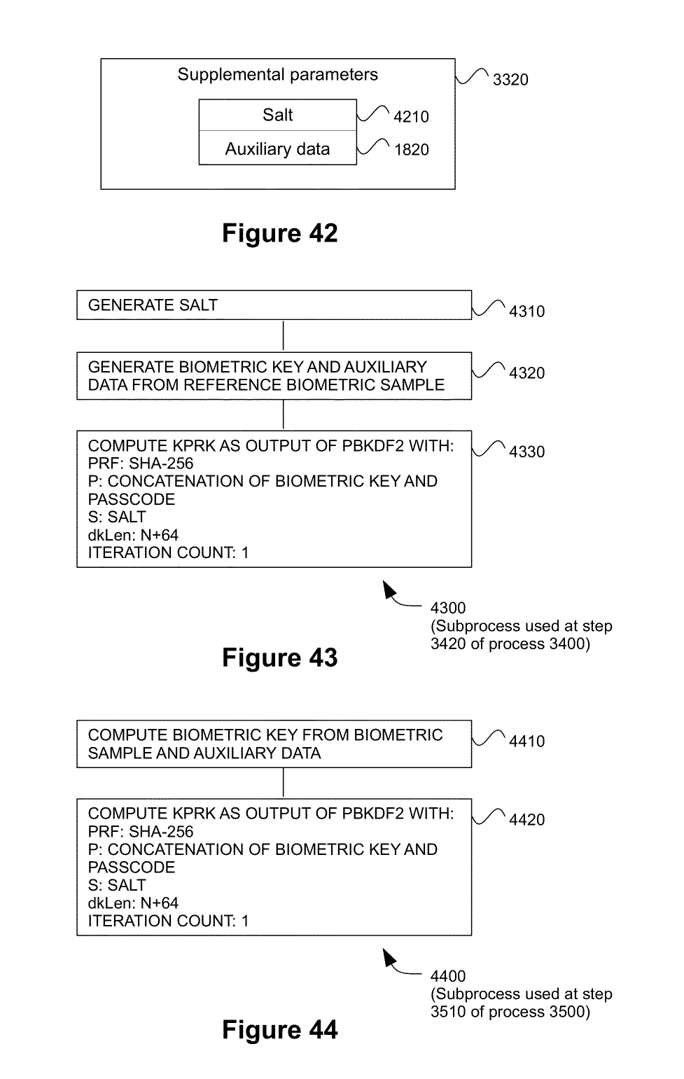

FIG. 42 is a block diagram illustrating the supplemental parameters 3320 according to some embodiments where the non-stored secrets 175 consist of a biometric sample 1710 and a passcode 1720 as illustrated in FIG. 17. The supplemental parameters consist of a salt 4210 and the same auxiliary data 1820 that is part of the derivation parameters 710 illustrated in FIG. 18. Different salts are used for different protocredentials.

FIG. 43 is a flow diagram illustrating a subprocess for generating the supplemental parameters 3320 of the protocredential 3300 and computing a KPRK from reference non-stored secrets 175, used at step 3420 of subprocess 3400, according to some embodiments where the non-stored secrets consist of a biometric sample 1710 and a passcode 1720 as illustrated in FIG. 17, and the supplemental parameters 3320 consist of the salt 4210 and the auxiliary data 1820 used to compute a biometric key, as illustrated in FIG. 42.

At 4310 the device generates the salt 4210 as a random 32-byte string. Then the subprocess continues at 4320.

At 4320 the device generates the biometric key and the auxiliary data from the biometric sample 1710 included in the reference non-stored secrets, as described in the biometric authentication literature referenced above. Then the subprocess continues at 4330.

At 4330 the device computes the KPRK using PBKDF2 with:
SHA-256 as PRF;
the concatenation of the biometric key generated at step 4320 and the passcode 1720 as the value of “P”;
the salt 4210 as the value of “S”;
N+64 as the value of “dkLen”, N being the bitlength of the parameter q in the protocredential 3300; and
1 as the iteration count.
   (In alternative embodiments, HKDF may be used instead of PBKDF2.) Then the subprocess terminates.

FIG. 44 is a flow diagram illustrating a subprocess 4400 for computing a KPRK from the supplemental parameters 3320 of the protocredential 3300 and newly supplied non-stored secrets 175, used at step 3510 of subprocess 3500, according to some embodiments where the non-stored secrets are as in FIG. 17 and the supplemental parameters are as in FIG. 42.

At 4410 the device computes a biometric key from the biometric sample 1710 included in the newly supplied non-stored secrets and the auxiliary data 1820 included in the supplemental parameters 3320. This biometric key coincides with the biometric key generated at step 4320 of subprocess 43 from the biometric sample included in the reference non-stored secrets. Then the subprocess continues at 4420.

At 4420 the device computes the KPRK using PBKDF2 with:
SHA-256 as PRF;
the biometric key computed at step 4410 as the value of “P”;
the salt 4210 as the value of “S”;
N+64 as the value of “dkLen”, N being the bitlength of the parameter q in the protocredential 3300; and
1 as the iteration count.
   (In alternative embodiments, HKDF may be used instead of PBKDF2.) Then the subprocess terminates.

FIG. 45 is a flow diagram illustrating a subprocess 4500 for storing a key, which is one of the externally stored keys 250, 312, 322, at key storage service 600, which is one of the key storage services 150, 310, 320 respectively, and registering verification data pertaining to the credential 3200, which is one of the credentials 165, 316, 326 respectively, according to some embodiments. The subprocess is used multiple times at step 2870 of process 2800, after the device has obtained an authorization code for storing the key in the service.

At 4510 the device computes the SHA-256 hash of the public key 3120 included in the credential 3200 for use as the verification data (i.e. the SHA-256 hash of the concatenation of the our strings encoding the parameters p, q, g, y of the public key.) Then the subprocess continues at 4520.

At 4520 the device establishes a secure connection to the key storage service, using the corresponding service information 160, 311 or 321. Then the subprocess continues at 4530.

At 4530 the device sends the authorization code, the stored-key record handle 3210, the key to be stored and the verification data to the key storage service. Then the subprocess continues at 4540.

At 4540 the key storage service checks if the authorization code is valid. If so, the subprocess continues at 4550. Otherwise the subprocess fails and the key is not stored.

At 4550 the key storage service checks if the stored-key record handle is unique within the stored-key record table. If so, the subprocess continues at 4560. Otherwise the subprocess fails and the key is not stored.

At 4560 the key storage service creates a record 630 in the table of stored-key records 620, with the stored-key record handle as the value of the STORED-KEY RECORD HANDLE field 640, the key to be stored as the value of the STORED KEY field 650, the verification data as the value of the VERIFICATION DATA field 660, and 0 as the value of the CONSECUTIVE FAILURE COUNTER field 670. In some embodiments the key storage service places information identifying a key storage subscription account, obtained via the authorization code, in the additional fields 680. Then the subprocess terminates.

FIG. 46 is a flow diagram illustrating a subprocess 4600 for registering verification data pertaining to a new credential with key storage service 600, as the new credential replaces current credential 3200 for authentication to the service, according to some embodiments. The subprocess is used multiple times at step 3080 of process 3000, the key storage service 600 being one of the key storage services 150, 310 or 320 of FIGS. 3 and 4. The new credential, generated at step 3070 of process 3000 comprises a new key pair pertaining to the same cryptosystem as the current credential 3200, i.e. to the DSA cryptosystem. The new credential comprises the same stored-key record handle 3210 as the current credential 3200.

At 4605 the device computes the SHA-256 hash of the public key portion of the key pair in the new credential for use as the new verification data. Then the subprocess continues at 4610.

At 4610 the device establishes a secure connection to the key storage service, using the corresponding service information 160, 311 or 321. Then the subprocess continues at 4615.

At 4615 the key storage service sends a nonce to the device over the secure connection. (The term “nonce” is used herein to refer to a random string that is only used once.) Then the subprocess continues at 4620.

At 4620 the device signs a challenge comprising the nonce, using the private key portion 3110 of the current credential 3200, as described in Section 4.6 of the DSS. In some embodiments where the secure connection is implemented using TLS as described above, the challenge also comprises a hash of the TLS server certificate presented by the key storage service during the TLS handshake. Then the subprocess continues at 4625.

At 4625 the device sends the signature on the challenge, the stored-key record handle, the public key portion 3120 of the current credential, and the new verification data computed at step 4610 to the key storage service. Then the subprocess continues at 4630.

At 4630 the key storage service verifies the signature on the challenge using the public key received at 4625, as described in Section 4.7 of the DSS. If the signature is correct, the subprocess continues at 4635. Otherwise the process fails.

At 4635 the key storage service looks in its table 620 of stored-key records for a record 630 whose STORED-KEY RECORD HANDLE field 640 contains the stored-key record handle received from the device at 4625. If such a record 630 is found, the process continues at 4640. Otherwise the process fails.

At 4640 the key storage service computes the SHA-256 hash of the public key received at 4625, and checks if it agrees with the value of the VERIFICATION DATA field 660 of the stored-key record found at 4635. If so, the process continues at 4645. Otherwise the process continues at 4650.

At 4645 the key storage service resets to 0 the value of the CONSECUTIVE FAILURE COUNTER field 670 of the stored-key record found at 4635. Then the process continues at 4655.

At 4655 the key storage service sets the new verification data as the value of the VERIFICATION DATA field 660 of the stored-key record found at 4635. Then the subprocess terminates successfully.

At 4650 the key storage service increments by 1 the value of the CONSECUTIVE FAILURE COUNTER field 650 of the stored-key record found at 4635. Then the process continues at 4660.

At 4660 the key storage service checks if the value of the CONSECUTIVE FAILURE COUNTER field has reached a configured limit. In some embodiments the configured limit is 5. If so, the process continues at 4665. Otherwise the process terminates with failure without further processing.

At 4665 the key storage service disables the stored-key record found at 4635. In one embodiment the service disables the record by setting a value indicating that the record is disabled in one of the additional fields 1680. In an alternative embodiment the service disables the record by deleting it from the table 620 of stored-key records. Then the process terminates with failure.

FIG. 47 is a flow diagram illustrating a subprocess 4700 by which the computing device 110 makes a request for an externally stored key from key storage service 600, using credential 3200 to authenticate the request, according to some embodiments. The subprocess is used at step 2730 of process 2700 after the device has established a secure connection to the key storage service at step 2720, the storage service 600 being one of the storage services 150, 310, 320 of FIGS. 3 and 4, and the credential 3200 being one of the credentials 165, 316, 326 respectively.

At 4705 the key storage service sends a nonce to the device over the secure connection. Then the subprocess continues at 4710.

At 4710 the device signs a challenge comprising the nonce, using the private key portion 3110 of the credential 3200, as described in Section 4.6 of the DSS; in some embodiments where the secure connection is implemented using TLS as described above, the challenge also comprises a hash of the TLS server certificate presented by the key storage service during the TLS handshake. Then the subprocess continues at 4715.

At 4715 the device sends the signature on the challenge, the stored-key record handle 3210 in the credential 3200, and the public key portion 3120 of the credential to the key storage service. Then the subprocess continues at 4720.

At 4720 the key storage service verifies the signature on the challenge using the public key received at 4715, as described in Section 4.7 of the DSS. If the signature is correct, the subprocess continues at 4725. Otherwise the process fails.

At 4725 the key storage service looks in its table 620 of stored-key records for a record 630 whose STORED-KEY RECORD HANDLE field 640 contains the stored-key record handle received from the device at 4715. If such a record 630 is found, the process continues at 4730. Otherwise the process fails.

At 4730 the key storage service computes the SHA-256 hash of the public key received at 4715, and checks if it agrees with the value of the VERIFICATION DATA field 660 of the stored-key record found at 4725. If so, the process continues at 4735. Otherwise the process continues at 4740.

At 4735 the key storage service resets to 0 the value of the CONSECUTIVE FAILURE COUNTER field 670 of the stored-key record found at 4725. Then the process continues at 4745.

At 4745 the key storage service sends the key stored in the STORED KEY field 650 of the stored-key record found at 4725 to the device. Then the process terminates successfully.

At 4740 the key storage service increments by 1 the value of the CONSECUTIVE FAILURE COUNTER field 650 of the stored-key record found at 4725. Then the process continues at 4750.

At 4750 the key storage service checks if the value of the CONSECUTIVE FAILURE COUNTER field has reached a configured limit. In some embodiments the configured limit is 5. If so, the process continues at 4755. Otherwise the process terminates with failure without further processing.

At 4755 the key storage service disables the stored-key record found at 4750. In one embodiment the service disables the record by setting a value indicating that the record is disabled in one of the additional fields 1680. In an alternative embodiment the service disables the record by deleting it from the table 620 of stored-key records. Then the process terminates with failure.

The confidential data that can be protected by the present invention may be of any kind

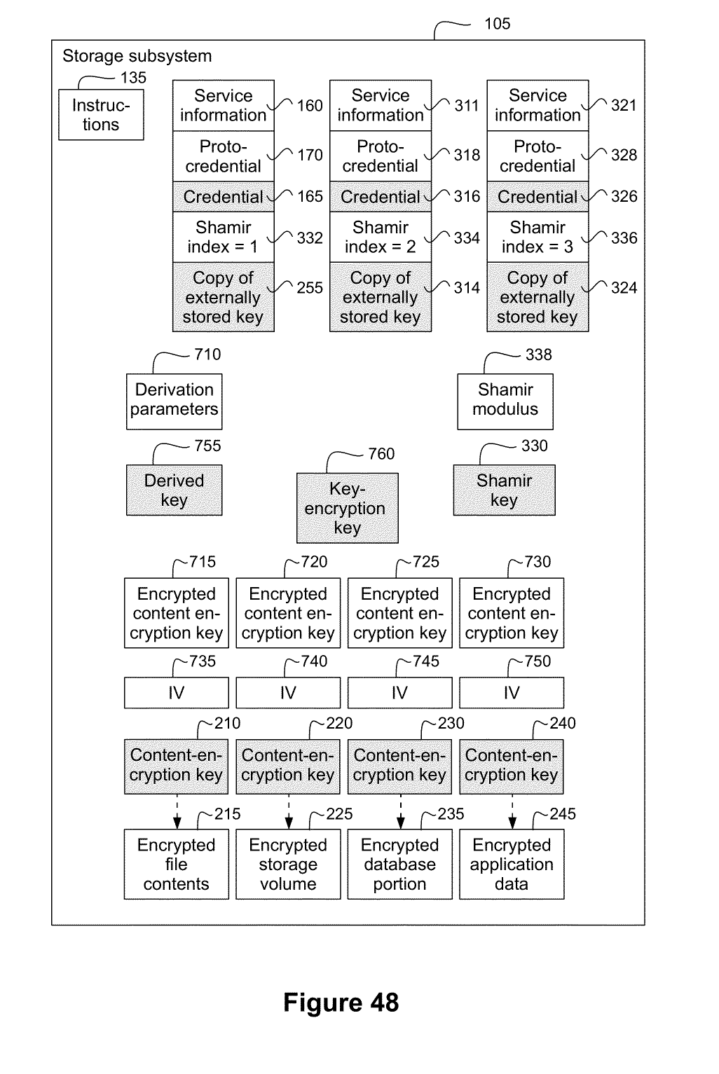

FIG. 48 is a block diagram illustrating the following kinds of encrypted data that may by present in the storage subsystem 105 of system 300 or 400:
encrypted file contents 215, which are decrypted when an application opens the file, and reencrypted when the application saves the file after updating it, using the content- encryption key 210;
an encrypted storage volume 225, such as a disk partition or an entire disk, blocks of the volume being decrypted and reencrypted on the fly by the operating system of the computing device as specified in the IEEE Standard 1619-2007 entitled “IEEE Standard for Cryptographic Protection of Data on Block-Oriented Storage Devices”, using the content-encryption key 220, so that the fact that the volume is encrypted is transparent to the applications that store data on the disk;
an encrypted database portion 235, such as a column, table or tablespace encrypted with transparent database encryption technology, using the content-encryption key 230; and
arbitrary application data 245, encrypted and decrypted as needed using the content-encryption key 240.

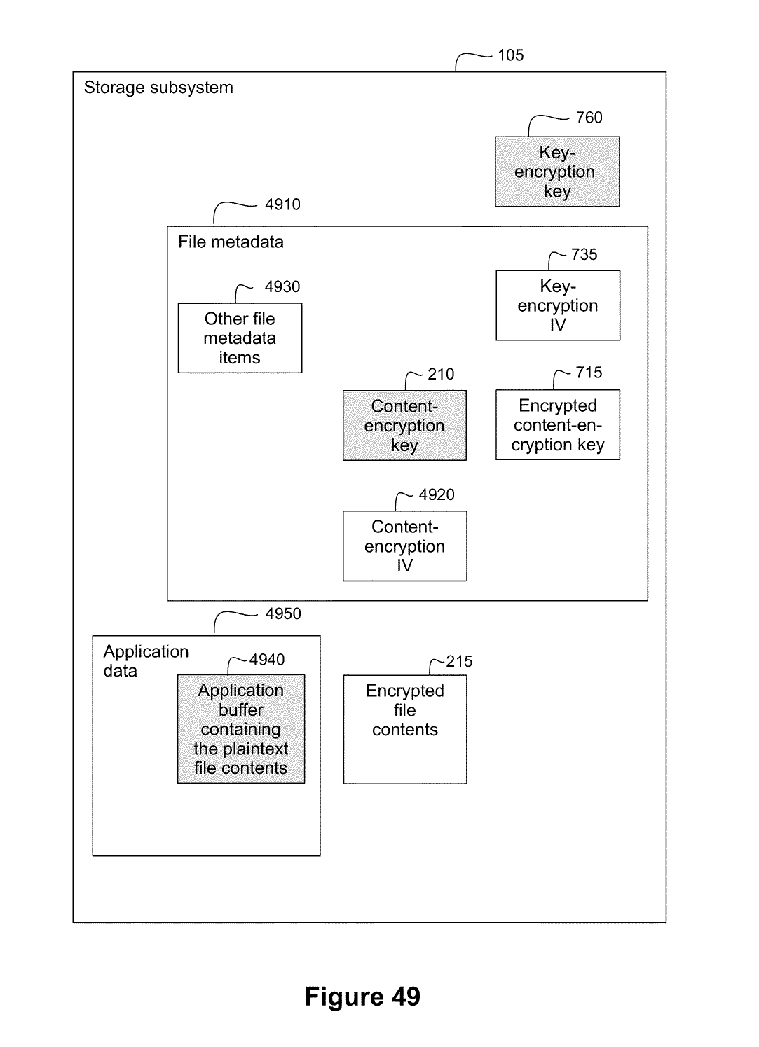

FIGS. 49, 50, 51 and 52 illustrate the storage of an encrypted file in the storage subsystem 105 of system 300 or 400 according to some embodiments where the computing device has an operating system that provides file encryption, as well as the creation, reading and writing of the file by an application while the device is unlocked. The operating system and the application consist of code that is included in the instructions 135.

FIG. 49 is a block diagram illustrating data related to the file stored in the storage subsystem. The content-encryption key 210, the encrypted content-encryption key 715, and the key encryption initialization vector (IV) 735 are part of the file metadata 4910 maintained by the operating system. A content encryption initialization vector 4920 is also part of the file metadata. The file metadata also comprises other file metadata items 4930 such as a file name, file permissions, timestamps, etc. Besides the file metadata 4910 and the encrypted file contents 215, the figure shows the key-encryption key 760 which is used to decrypt the content-encryption key 210 and other content-encryption keys when the user unlocks the device, and an application buffer 4940, which contains plaintext file contents while the application is working on the file, and is part of application data 4950.

The Advanced Encryption Standard (AES, referenced above) in Cipher-Block Chaining mode (CBC mode, reference above) is used for encryption and decryption of the file contents and of the content encryption key. The size of the content-encryption key as well as the size of the key-encryption key is 256 bits, i.e. 32 bytes. (In alternative embodiments the size of either key may be 138 bits or 192 bits.) The size of the key initialization vectors is 128 bits, i.e. 16 bytes.

In some embodiments, the contents of the plaintext content-encryption key 210 are erased by the operating system at step 2970 of process 2900, which the operating executes when the user locks the device, while the contents of the application buffer 4940 are erased by the application when it is notified by the operating system that the device is being locked.

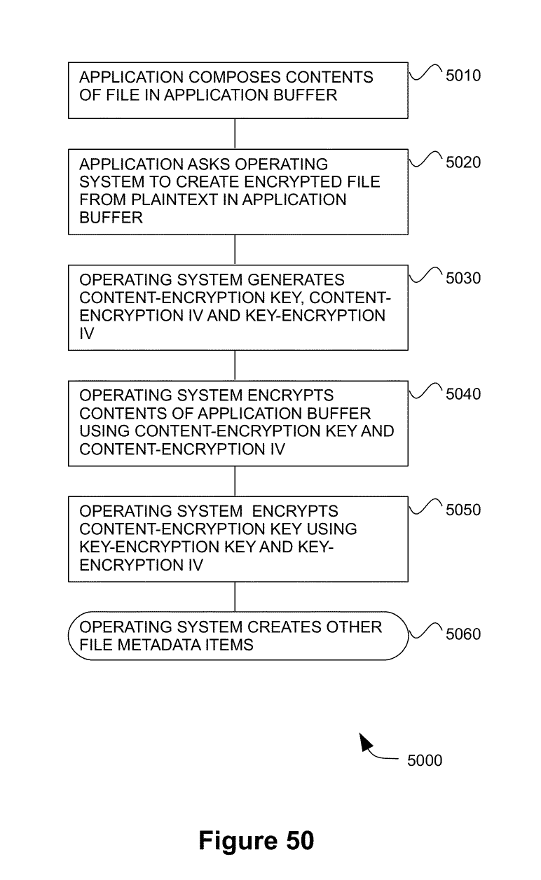

FIG. 50 is a flow diagram illustrating a process 5000 for creating the file.

At 5010 the application composes the contents of the file in the application buffer 4940. Then the process continues at 5020.

At 5020 the application asks the operating system to create an encrypted file from the plaintext in the application buffer 4940. This step may take place, for example, when the user 120 asking the application to save the data in the application buffer as a file. Then the process continues at 5030.

At 5030 the operating system generates the content-encryption key 210 as a random 32-byte string, the content-encryption IV 4920 as a random 16-byte string, and the key-encryption IV 735 also as a random 16-byte string. Then the process continues at 5040.

At 5040 the operating system computes the encrypted file contents 215 by encrypting the contents of the application buffer 4940 using the content-encryption key 210 and the content-encryption IV 4920. Then the process continues at 5050.

At 5050 the operating system computes the encrypted content-encryption key 715 by encrypting the content-encryption key 210 using the key-encryption key 760 and the key-encryption IV 735. Then the process continues at 5056.

At 5060 the operating system creates the other file metadata items 4930. Then the operating system reports to the application that the file has been created and the process terminates.

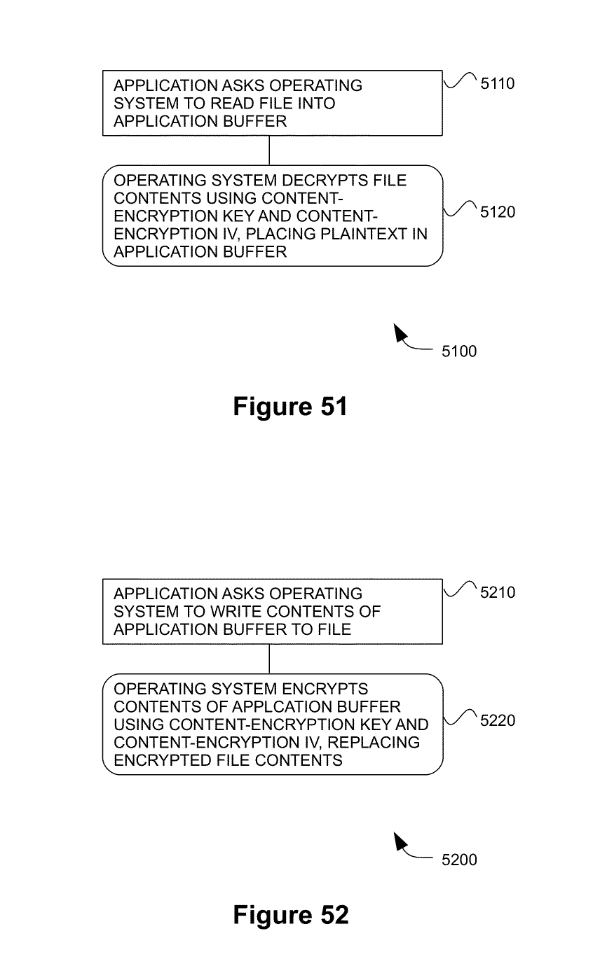

FIG. 51 is a flow diagram illustrating a process 5100 for reading the file.

At 5110 the application asks the operating system to place the plaintext contents of the file into the application buffer 4940. This step may take place, for example, when the user asks the application to open the file. Then the process continues at 5120.

At 5120 the operating system decrypts the encrypted file contents 215 using the content-encryption key 210 and the content-encryption IV 4920, and places the resulting plaintext into the application buffer 4920. Then the operating system reports to the application that the file has been read and the process terminates.

FIG. 52 is a flow diagram illustrating a process 5200 for writing the file.

At 5210 the application asks the operating system to write the contents of the application buffer 4940 to the file. Then the process continues at 5220.

At 5220 the operating system encrypts the contents of the application buffer 4940 using the content-encryption key 210 and the content-encryption IV 4920, and replaces the encrypted file contents 215 with the resulting ciphertext. Then the operating system reports to the application that the file has been written and the process terminates.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein.

What is claimed is:

1. A method of protecting confidential data stored in a computing device, comprising:
storing the confidential data in encrypted form;
regenerating a credential from a protocredential stored in the device and one or more secrets not stored in the device;
requesting a content-encryption key from a key storage service, the credential being used to authenticate the request; and
using the content-encryption key to decrypt the confidential data.

2. A method of protecting confidential data stored in a computing device, comprising:
storing the confidential data in encrypted form;
regenerating a credential from a protocredential stored in the device and one or more secrets not stored in the device;
requesting an externally stored key from a key storage service, the credential being used to authenticate the request;
performing a computation of a content-encryption key using the externally stored key as an input to the computation; and
using the content-encryption key to decrypt the confidential data.

3. The method of claim 2, wherein the computation of the content-encryption key takes as further inputs one or more additional externally stored keys retrieved from one or more key storage services and includes computing a key from a plurality of externally stored keys using secret sharing.

4. The method of claim 2, wherein the computation takes as further inputs the one or more secrets not stored in the device.

5. The method of claim 2, wherein the computation takes as a further input a hardware key.

6. The method of claim 2, wherein the credential comprises a private key that is part of a key pair pertaining to a public key cryptosystem.

7. The method of claim 2, wherein the one or more secrets not stored in the device comprise a passcode.

8. The method of claim 7, wherein regenerating the credential comprises deriving a parameter of the credential from the passcode by means of a key derivation function.

9. The method of claim 2, wherein the one or more secrets not stored in the device comprise a biometric sample.

10. A computing device, comprising:
one or more processors; and
a storage subsystem containing encrypted confidential data and containing instructions executable by the one or more processors for:
regenerating a credential from a protocredential stored in the device and one or more secrets not stored in the device;
requesting an externally stored key from a key storage service, the credential being used to authenticate the request;
performing a computation of a content-encryption key using the externally stored key as an input to the computation; and
using the content-encryption key to decrypt the confidential data.

11. The computing device of claim 10, wherein the computation of the content-encryption key takes as further inputs one or more additional externally stored keys retrieved from one or more key storage services and includes computing a key from a plurality of externally stored keys using secret sharing.

12. The computing device of claim 10, wherein the computation takes as further inputs the one or more secrets not stored in the device.

13. The computing device of claim 10, wherein the computation takes as a further input a hardware key.

14. The computing device of claim 10, wherein the credential comprises a private key that is part of a key pair pertaining to a public key cryptosystem.

15. The computing device of claim 10, wherein the one or more secrets not stored in the device comprise a passcode, and regenerating the credential comprises deriving a parameter of the credential from the passcode by means of a key derivation function.

16. The computing device of claim 10, wherein the confidential data comprises the contents of a file.

17. The computing device of claim 10, wherein the confidential data comprises a storage volume.

18. A system, comprising:
a computing device;
a key storage service containing an externally stored key of the computing device; and
a network connecting the computing device to the key storage service,
wherein the computing device comprises:
one or more processors; and
a storage subsystem containing encrypted data and containing instructions executable by the one or more processors for:
regenerating a credential from a protocredential stored in the device and one or more secrets not stored in the device;
requesting an externally stored key from a key storage service, the credential being used to authenticate the request;
performing a computation of a content-encryption key using the externally stored key as an input to the computation; and
using the content-encryption key to decrypt the confidential data.

19. The system of claim 18, wherein the key storage service disables a record containing the externally stored key after a configured number of consecutive authentication failures of requests for the externally stored key.

20. The system of claim 19, wherein the credential comprises a private key that is part of a key pair pertaining to a public key cryptosystem, the one or more secrets not stored in the device comprise a passcode, and regenerating the credential comprises deriving a parameter of the credential from the passcode by means of a key derivation function.
